(19) United States
(12) Patent Application Publication
(10) Pub. No.: US 2018/0165114 A1
(43) Pub. Date: Jun. 14, 2018

(54) CONTROL DEVICE AND CONTROL METHOD

(71) Applicant: FUJITSU LIMITED, Kawasaki-shi (JP)

(72) Inventors: Takamichi NISHIJIMA, Kawasaki (JP); Shinya KANO, lnagi (JP)

(73) Assignee: FUJITSU LIMITED, Kawasaki-shi (JP)

(21) Appl. No.: 15/824,020

(22) Filed: Nov. 28, 2017

(30) Foreign Application Priority Data
Dec. 14, 2016 (JP) 2016-242588

(51) Int. Cl. G06F 9/455; H04L 12/26

(52) U.S. Cl. CPC G06F 9/45558; H04L 43/0876; G06F 2009/45595; G06F 2009/45583; G06F 2009/4557

(57) ABSTRACT

There is provided a control device configured to control a plurality of virtual machine groups arranged on a plurality of stages, the plurality of virtual machine groups performing predetermined functions, the control device including a memory, and a processor coupled to the memory and the processor configured to specify, when a first virtual machine is added into a first virtual machine group of the plurality of virtual machine groups configured to perform a first function of the predetermined functions, a second virtual machine group of the plurality of virtual machine groups configured to perform a second function of the predetermined functions, the second virtual machine group being arranged on a forefront stage of the plurality of stages, and add a second virtual machine into the second virtual machine group based on a number of second virtual machines in the second virtual machine group.

### CROSS-REFERENCE TO RELATED APPLICATION

This application is based upon and claims the benefit of priority of the prior Japanese Patent Application No. 2016-242588, filed on Dec. 14, 2016, the entire contents of which are incorporated herein by reference.

### FIELD

The embodiments discussed herein are related to a control device and a control method.

### BACKGROUND

In a recent network, there is a service chain system that transfers packets using a network (NW) function such as a firewall (FW) or a web proxy (Proxy) virtually arranged on a communication path upon request when making an access from a base site to an external site or another base site. A communication path that passes through a virtual NW function is called a service chain.

In the related art, the NW function works in a physical NW device such as an NW server. However, owing to recent improvements in performance of general-purpose servers, the NW function may also work in a software processing on the general-purpose servers. Accordingly, the operation of the NW function is beginning in the form of operating a program of the NW function under a virtualization environment of the general-purpose servers. A software processing related to the NW operating under the virtualization environment is referred to as a virtual network function (VNF).

However, as a result of shifting the operation mode of the NW-related processing such as data transfer from the physical NW device to the VNF of the software processing on the general-purpose servers, the processing performance of data transfer is deteriorated. For this reason, the processing performance of data transfer is improved by executing a plurality of programs in parallel and scaling out virtual machines in parallel on a plurality of servers to distribute the load of data transfer.

FIG. 16 is an explanatory view illustrating an example of an arrangement configuration of a service chain. The service chain 200 illustrated in FIG. 16 is constructed by arranging VNFs 201 each having a virtual machine (VM), in a plurality of stages. The VM is an NW function such as an FW 201A, an intrusive detection system (IDS) 201B, or a Proxy 201C. Further, the service chain 200 includes a load balancer (LB) 202 arranged in the front stage of the VNFs 201 in order to distribute traffics. The LB 202 distributes the traffics to VMs in the VNFs 201 to be arranged in the next stage. As a result, by distributing the input traffics, the LB 202 suppresses the deterioration of processing performance caused by implementing the functions with software.

Related techniques are disclosed in, for example, Japanese Laid-Open Patent Publication No. 2015-149578 and Japanese Laid-Open Patent Publication No. 2015-138425.

### SUMMARY

According to an aspect of the invention, a control device is configured to control a plurality of virtual machine groups arranged on a plurality of stages, the plurality of virtual machine groups perform predetermined functions, the control device includes a memory, and a processor coupled to the memory and the processor configured to specify, when a first virtual machine is added into a first virtual machine group of the plurality of virtual machine groups configured to perform a first function of the predetermined functions, a second virtual machine group of the plurality of virtual machine groups configured to perform a second function of the predetermined functions, the second virtual machine group being arranged on a forefront stage of the plurality of stages, and add a second virtual machine into the second virtual machine group based on a number of second virtual machines in the second virtual machine group.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory view illustrating an example of a service chain system;

FIG. 2 is an explanatory view illustrating an example of a hardware configuration of a management server;

FIG. 3A is an explanatory view illustrating an example of a service chain;

FIG. 3B is an explanatory view illustrating an example of a service chain after adding a VM;

FIG. 4A is an explanatory view illustrating an example of a service chain of a pattern that cannot distribute traffics to all VMs when a VM is added;

FIG. 4B is an explanatory view illustrating an example of a service chain after adding a VM;

FIG. 5 is an explanatory view illustrating an example of a functional configuration of a processor of a management server according to the first embodiment;

FIG. 6 is an explanatory view illustrating an example of a table configuration of a configuration table;

FIG. 7 is an explanatory view illustrating an example of a table configuration of a VM management table;

FIGS. 8A and 8B are explanatory views illustrating an example of an operation of a management server at the time of detecting an overload of VNF#3 in a service chain according to the first embodiment;

FIGS. 8C and 8D are explanatory views illustrating an example of an operation of the management server at the time of adding a VM of VNF#3;

FIGS. 8E and 8F are explanatory views illustrating an example of an operation of the management server at the time of specifying a source VNF;

FIGS. 8G and 8H are explanatory views illustrating an example of an operation of the management server at the time of extracting the number of source VMs and the number of additional VMs;

FIGS. 8I and 8J are explanatory views illustrating an example of an operation of the management server at the time of adding a VM of a source VNF#1;

FIGS. 8K and 8L are explanatory views illustrating an example of an operation of the management server at the time of resetting path;

FIG. 9 is a flowchart illustrating an example of a processing operation of a processor in a management server related to a first VM adding process;

FIGS. 10A and 10B are explanatory views illustrating an example of an operation of a management server at the time of detecting an overload of VNF#3 in a service chain according to a second embodiment;

FIGS. 10C and 10D are explanatory views illustrating an example of an operation of the management server at the time of adding a VM of VNF#3 and specifying a source VNF;

FIGS. 10E and 10F are explanatory views illustrating an example of an operation of the management server at the time of extracting the number of source VMs, the number of additional VMs, and the number of destination VMs;

FIGS. 10G and 10H are explanatory views illustrating an example of an operation of the management server at the time of adding a VM of a source VNF#1;

FIGS. 10I and 10J are explanatory views illustrating an example of an operation of the management server at the time of resetting path;

FIGS. 11A and 11B are explanatory views illustrating an example of an operation of the management server at the time of detecting an overload of VNF#3 in a service chain;

FIGS. 11C and 11D are explanatory views illustrating an example of an operation of the management server at the time of adding a VM of VNF#3 and specifying a source VNF;

FIGS. 11E and 11F are explanatory views illustrating an example of an operation of the management server at the time of extracting the number of source VMs and the number of additional VMs;

FIGS. 11G and 11H are explanatory views illustrating an example of an operation of the management server at the time of adding a VM of a source VNF#1;

FIGS. 11I and 11J are explanatory views illustrating an example of an operation of the management server at the time of resetting path;

FIGS. 12A and 12B are flowcharts illustrating an example of a processing operation of a processor in a management server related to a second VM adding process;

FIGS. 13A and 13B are explanatory views illustrating an example of an operation of a management server at the time of detecting an overload of VNF#4 in a service chain according to a third embodiment;

FIGS. 13C and 13D are explanatory views illustrating an example of an operation of the management server at the time of adding VMs of VNF#3 and VNF#4;

FIGS. 13E and 13F are explanatory views illustrating an example of an operation of the management server at the time of adding a VM of VNF#2;

FIGS. 13G and 13H are explanatory views illustrating an example of an operation of the management server at the time of specifying a source VNF;

FIGS. 13I and 13J are explanatory views illustrating an example of an operation of the management server at the time of resetting path;

FIGS. 14A and 14B are flowcharts illustrating an example of a processing operation of a processor in a management server related to a third VM adding process;

FIG. 14C is a flowchart illustrating an example of a processing operation of the processor in the management server related to the third VM adding process;

FIG. 15 is an explanatory view illustrating an example of an information processing apparatus that executes a control program; and

FIG. 16 is an explanatory view illustrating an example of an arrangement configuration of a service chain.

### DESCRIPTION OF EMBODIMENTS

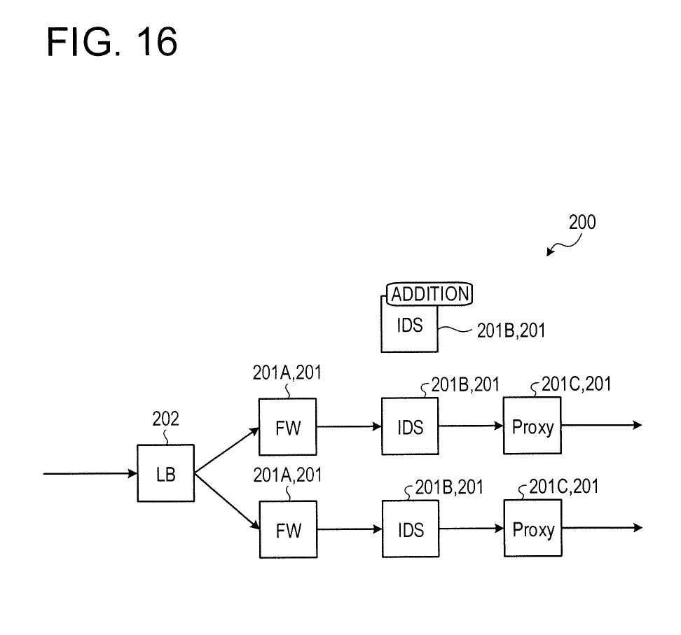

Referring back to FIG. 16, in the service chain 200, for example, when an overload occurs in the VNF 201B, the processing load of the overloaded VNF 201B may be reduced by adding a VM (IDS) to the overloaded VNF 201B. However, in the service chain 200, even when a VM is added to the VNF 201B, there is a case where the traffics may not be distributed to the added VM and accordingly, the processing load of the overloaded VNF 201B may not be reduced. In this case, it is conceivable to place an LB 202 at the previous stage of the VNF 201B. However, placing the LB 202 may cause a transfer delay.

Hereinafter, exemplary embodiments of a technology capable of distributing traffics to all virtual machines even when a virtual machine is added will be described in detail with reference to the accompanying drawings. The disclosed technology is not limited by the embodiments. Further, the following embodiments may be used in proper combination unless contradictory.

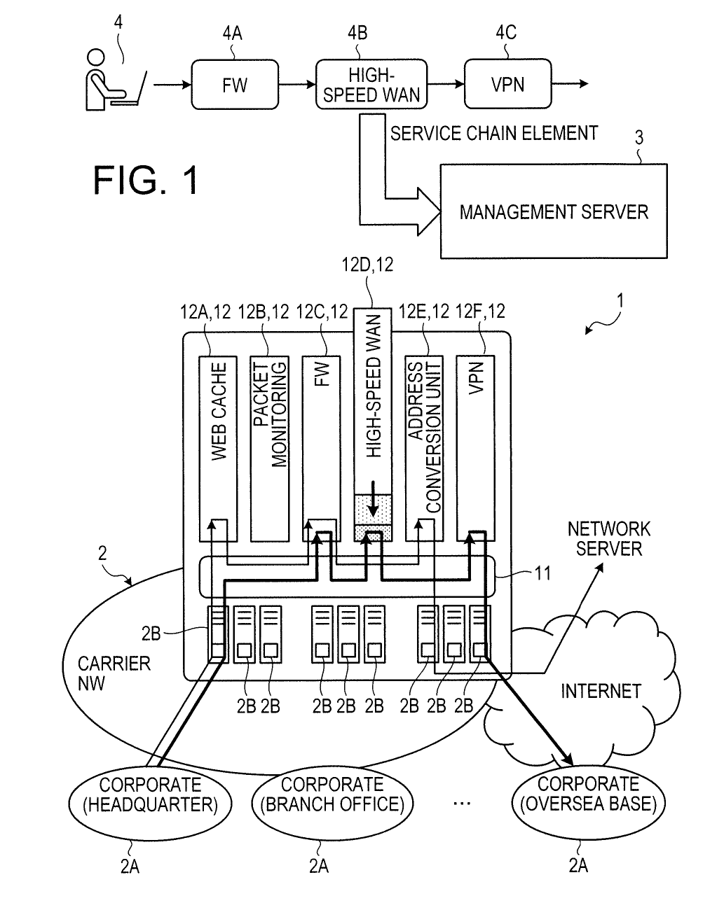

FIG. 1 is an explanatory view illustrating an example of a service chain system 1. The service chain system 1 illustrated in FIG. 1 includes a carrier NW 2, a management server 3, and a terminal device 4. The carrier NW 2 is, for example, a network that is connected to base sites 2A such as a corporate headquarters, a branch office, and an overseas base. The carrier NW 2 includes, for example, a plurality of general-purpose servers 2B, a virtual NW 11 operating in a virtual area in a resource area of each general-purpose server 2B, and a plurality of VNFs 12 arranged on the virtual NW 11. The management server 3 establishes a service chain to communicate between the base sites 2A in the virtual area.

The VNFs 12 are virtual NW functions such as a Web Cache 12A, a packet monitoring 12B, an FW 12C, a high-speed WAN 12D, an address conversion unit 12E, a virtual private network (VPN) router 12F, an IDS, and a Proxy. The Web Cache 12A is a NW function that stores cache data with a web server (not illustrated). The packet monitoring 12B is a NW function that monitors the state of packets on a communication path. The FW 12C is a NW function that suppresses unauthorized accesses. The high-speed WAN 12D is a NW function such as a high-speed WAN. The address conversion unit 12E is a NW function that converts an address. The VPN 12F is a NW function such as a router of a virtual leased line. The IDS is a NW function that detects unauthorized intrusions from the outside. The Proxy (Web Proxy or Web Cache) is a NW function of a proxy server. The VNF 12 is a virtual communication function virtually arranged in a virtual area on the general-purpose server 2B.

The management server 3 is a control device that arranges desired virtual NW 11 and VNF 12 on the virtual area of each general-purpose server 2B in the carrier NW 2 according to a configuration request of a service chain from the terminal device 4. The terminal device 4 is, for example, a terminal device such as a system administrator that accesses the management server 3 via the FW 4A, the high-speed WAN 4B, the VPN 4C, or the like and instructs the management server 3 to request the configuration of the service chain. The configuration request is a command for requesting the arrangement of one or more VNFs 12 on a communication path on which packets are transferred. In addition to specifying the number of instances of the VNF 12 and LB, the configuration request may specify only the number of instances of the VNF 12. Further, the configuration request may specify, for example, the required quality of the service chain. When detecting the configuration request specifying the required quality, the management server 3 determines the number of instances of the VNF 12 and LB from the desired function and the load condition specified by the configuration request.

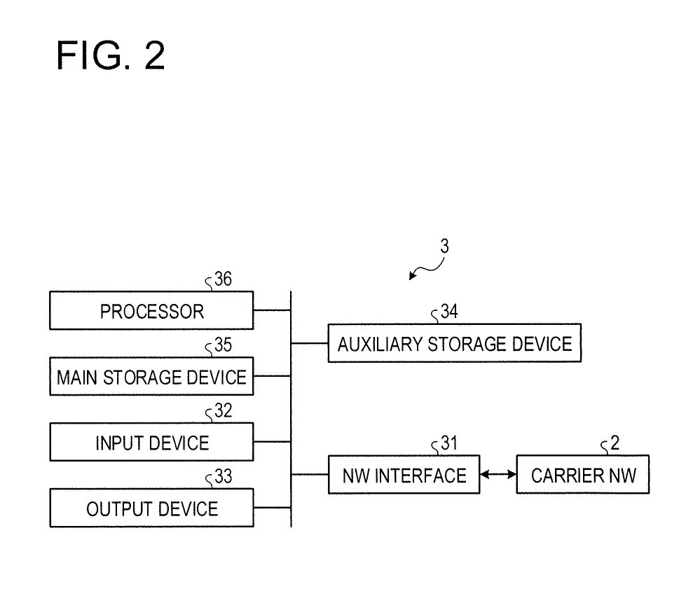

FIG. 2 is an explanatory view illustrating an example of a hardware configuration of the management server 3. The management server 3 illustrated in FIG. 2 corresponds to, for example, a dedicated computer or a general-purpose computer serving as a NW server. The management server 3 includes a NW interface 31, an input device 32, an output device 33, an auxiliary storage device 34, a main storage device 35, and a processor 36. The NW interface 31 is a communication interface connected to the carrier NW 2 and the VNF 12. The NW interface 31 is, for example, a communication interface responsible for wired or wireless communication. The NW interface 31 is, for example, a communication card such as a network interface card (NIC) or a local area network (LAN) card.

The input device 32 is an input interface for inputting various kinds of information, for example, a pointing device such as a keyboard or a mouse. The output device 33 is an output interface for outputting various kinds of information such as, for example, an audio output device or a display device. The auxiliary storage device 34 is a nonvolatile memory such as an erasable programmable ROM (EPROM) or a hard disk drive (HDD) configured to store various kinds of information such as various kinds of programs and data used by the processor 36. Further, the auxiliary storage device 34 is an area holding, for example, an operating system (OS) and various other application programs.

The main storage device 35 is a semiconductor memory such as a random access memory (RAM) configured to provide an area or a work area into which various kinds of information such as, for example, a program stored in the auxiliary storage device 34, is loaded. The processor 36 is, for example, a control unit such as a central processing unit (CPU) that controls the management server 3 in its entirety. The processor 36 executes various processing functions by loading and executing an OS and various application programs stored in the auxiliary storage device 34 or a portable recording medium into the main storage device 35. The number of processors 36 is not limited to one but may be two or more.

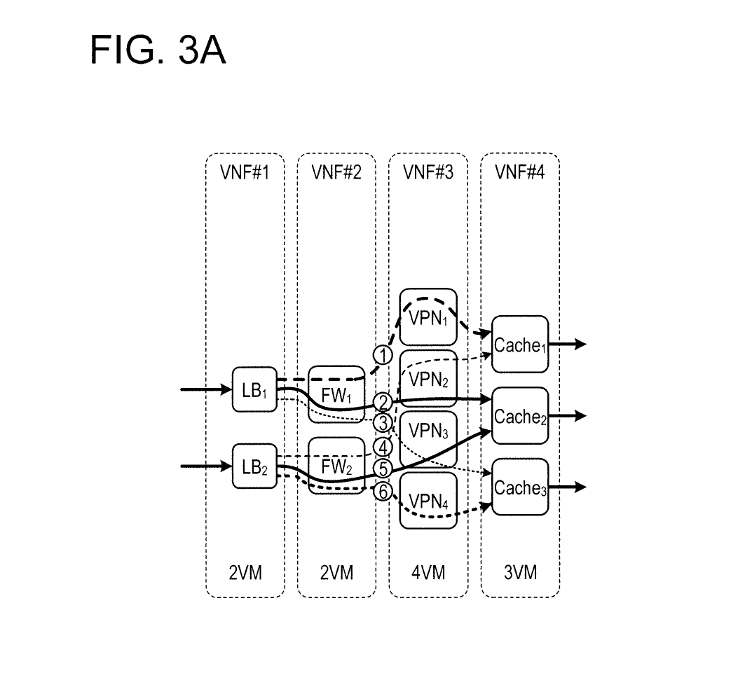

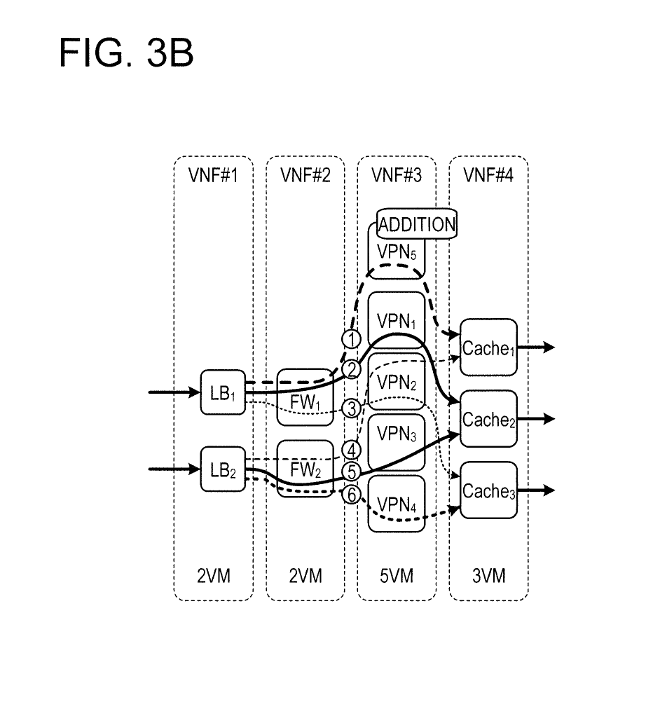

FIG. 3A is an explanatory view illustrating an example of a service chain. The service chain illustrated in FIG. 3A is constructed by arranging VNF#1 to VNF#4 in a plurality of stages. For example, the VNF#1 has two VMs of LB₁ and LB₂ of a terminating VNF, and the VNF#2 has two VMs of FW₁ and FW₂ of a non-terminating VNF. For example, the VNF#3 has four VMs of VPN₁ to VPN₄ of a non-terminating VNF and the VNF#4 has three VMs of Cache₁ to Cache₃ of a terminating VNF. For example, LB₁ and LB₂ assume each VM (Cache₁ to Cache₃) of the VNF#4 that terminates the output traffics, as a VM of a destination address of the traffics. LB₁ divides an input traffic into three lines of traffics and outputs each traffic to each VM (Cache₁ to Cache₃) in the destination VNF#4. LB₂ divides an input traffic into three lines of traffics and outputs each traffic to each VM (Cache₁ to Cache₃) in the destination VNF#4.

The number of traffics from LB₁ and LB₂ in VNF#1 is six lines in total. The VNF#1 outputs traffics through the six lines to Cache₁ to Cache₃ in VNF#4, which is the destination VNF, via VNF#2 and VNF#3. In the service chain, since the total number of traffics is 6 lines, the traffics may be distributed to all the VMs in the VNFs by controlling a transfer path.

As a result, in the service chain, since LB is placed only in the VNF#1 at the first stage, the traffics are distributed to the LB, and the traffics pass through all the VMs in each VNF by controlling a traffic transmission path, the traffics may be distributed to all the VMs. In the service chain, since LB is placed only in the VNF#1 at the first stage, the traffics may be distributed to all VMs on the transfer path while reducing a processing delay of VNF#2 to VNF#4. Moreover, since the division ratio of traffics may be adjusted by the LB at the first stage, the loads of VMs may be equalized.

Further, the management server 3 monitors the load of each VM in the VNF in the service chain and detects the overload of the VNF when the load of the VM exceeds a predetermined threshold. Furthermore, when detecting the overload of the VNF, the management server 3 executes an auto scale which automatically adds a VM to the overloaded VNF.

FIG. 3B is an explanatory view illustrating an example of a service chain after adding a VM. Upon detecting the overload of VNF#3 in the service chain illustrated in FIG. 3A, the management server 3 adds one VM to VNF#3 as illustrated in FIG. 3B. Even when the number of VMs of VNF#3 between VNF#1 and VNF#4 is changed to five, the management server 3 may control transfer paths of a total of six lines of traffics to distribute the traffics to all VMs including the additional VM.

In the service chain illustrated in FIG. 3B, even when a VM (VPN₅) is added to the overloaded VNF#3, the traffics may be distributed to all VMs including the additional VM by controlling a transfer path. However, even when a VM is added at the time of overload, there is a pattern of the service chain in which the traffics may not be allocated and may not be distributed to all VMs in the VNF.

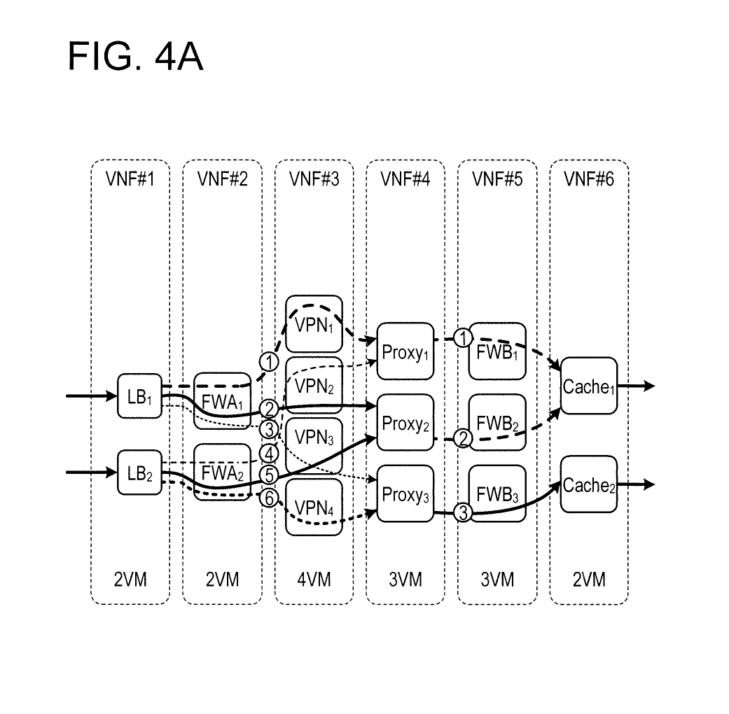

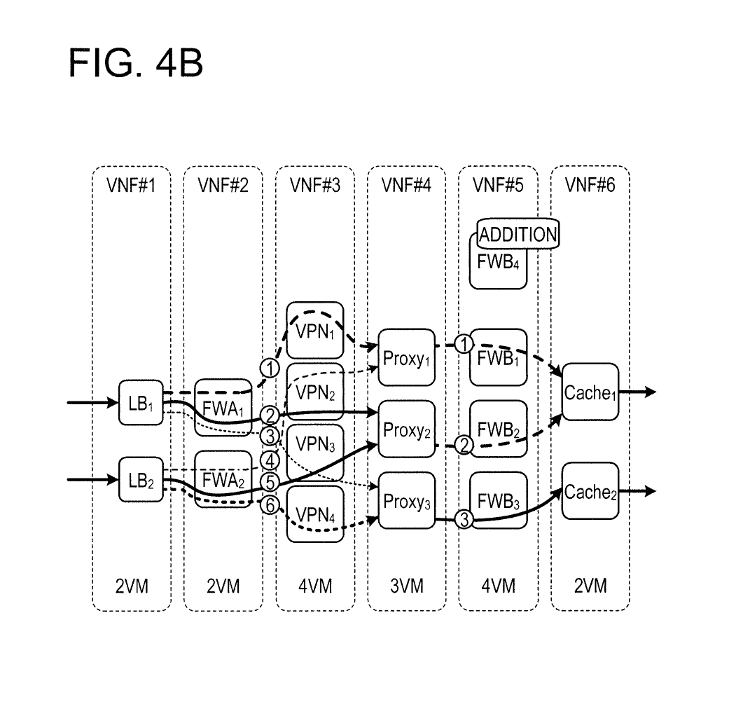

FIG. 4A is an explanatory view illustrating an example of a service chain of a pattern that may not distribute traffics to all VMs when a VM is added. The service chain illustrated in FIG. 4A is constructed by arranging VNF#1 to VNF#6 in a plurality of stages. For example, the VNF#1 has two VMs of LB₁ and LB₂ of a terminating VNF and the VNF#2 has two VMs of FWA₁ and FWA₂ of a non-terminating VNF. For example, the VNF#3 has four VMs of VPN₁ to VPN₄ of a non-terminating VNF, and the VNF#4 has three VMs of Proxy₁ to Proxy₃ of a terminating VNF. For example, the VNF#5 has three VMs of FWB₁ to FWB₃ of a non-terminating VNF, and the VNF#6 has two VMs of Cache₁ and Cache₂ of a terminating VNF. The traffic destination of VNF#1 is a VM (Proxy₁ to Proxy₃) of VNF#4. The traffic destination of Proxy of VNF#4 is a VM (Cache₁ and Cache₂) of VNF#6. It is to be noted that Proxy of VNF#4 and Cache of VNF#6 are a non-LB terminating VNF.

In a VM of a non-LB terminating VNF, there is one destination VM at a destination address of a traffic that the VM outputs. For example, since Proxy of the terminating VNF#4 is non-LB, when receiving a traffic destined for itself among traffics divided by the LB at the first stage, the received traffic is output to one destination VM. Therefore, since there are three VMs in VNF#4, only three lines of traffics flow.

When detecting the overload of VM (FWB) of VNF#5 in the service chain, the management server 3 executes an auto scale which adds one VM (FWB₄) to VNF#5 as illustrated in FIG. 4B.

As a result, in the service chain illustrated in FIG. 4B, one VM (FWB₄) is added for getting rid of an overload of VNF#5, totaling four VMs (FWB₁ to FWB₄). However, in the service chain, even when a transfer path is controlled, since there are only three lines of traffics, the traffics may not be distributed to the four VMs in VNF#5. As a result, even when FWB₄ is added to VNF#5, since no traffic may be allocated to the additional VM, the traffics may not be distributed to all VMs and accordingly, the overload of VNF#5 may not be reduced. A service chain system for coping with such a situation will be described below according to a first embodiment. In the first embodiment, the same configurations as those in the service chain system illustrated in FIGS. 1 and 2 are denoted by the same reference numerals and explanation on the overlapping configuration and operation thereof will not be repeated.

### First Embodiment

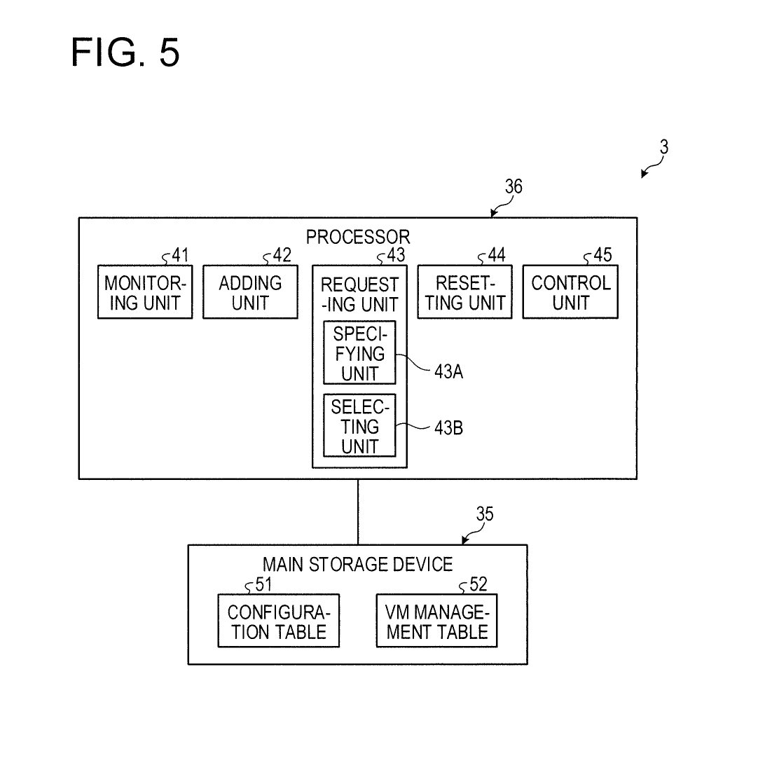

FIG. 5 is an explanatory view illustrating an example of a functional configuration of a processor 36 of a management server 3 according to a first embodiment. The management server 3 illustrated in FIG. 5 has the above-described processor 36 and main storage device 35. The processor 36 includes a monitoring unit 41, an adding unit 42, a requesting unit 43, a resetting unit 44, and a control unit 45.

The monitoring unit 41 monitors the load of each VM in each VNF constituting a service chain, for example, a CPU usage rate. When the CPU usage rate exceeds a predetermined threshold value (e.g., 80%), the monitoring unit 41 detects an overload of the VNF. When detecting the overload of the VNF, the monitoring unit 41 notifies the adding unit 42 of an addition request for adding a VM to the overloaded VNF.

In response to the addition request, the adding unit 42 activates a VM acting as a VNF constituting the service chain on the general server 2B and adds the VM to the VNF. In response to the addition of the VM, the requesting unit 43 determines whether or not there are other VMs to be added in conjunction with the addition of the VM. When it is determined that there are other VMs to be added, the requesting unit 43 notifies the adding unit 42 of a VM addition request. The requesting unit 43 includes a specifying unit 43A and a selecting unit 43B. The specifying unit 43A specifies a source VNF at a source address of a traffic passing through the additional VNF including the additional VM. Further, the additional VNF is, for example, a VNF that executes a first function and the source VNF is, for example, a VNF that executes a second function. The selecting unit 43B selects a source VNF or a destination VNF as a VM to be added in conjunction. The destination VNF is, for example, a VNF that executes a third function. In the first embodiment, for convenience of explanation, it is assumed that the selecting unit 43B selects a source VNF in advance. The requesting unit 43 compares the number of VMs of the source VNF, that is, the number of source VMs, with the number of VMs of the additional VNF, that is, the number of additional VMs. Further, based on a result of the comparison between the number of source VMs and the number of additional VMs, when the number of source VMs is smaller, the requesting unit 43 notifies the adding unit 42 of an addition request to add a VM to the source VNFs. When the configuration of the service chain is changed in response to the addition request, the resetting unit 44 recalculates an allocation setting of LB and a transfer path of VNF, sets the allocation setting in LB, and sets the transfer path in each VNF. The control unit 45 controls the overall operation of the processor 36.

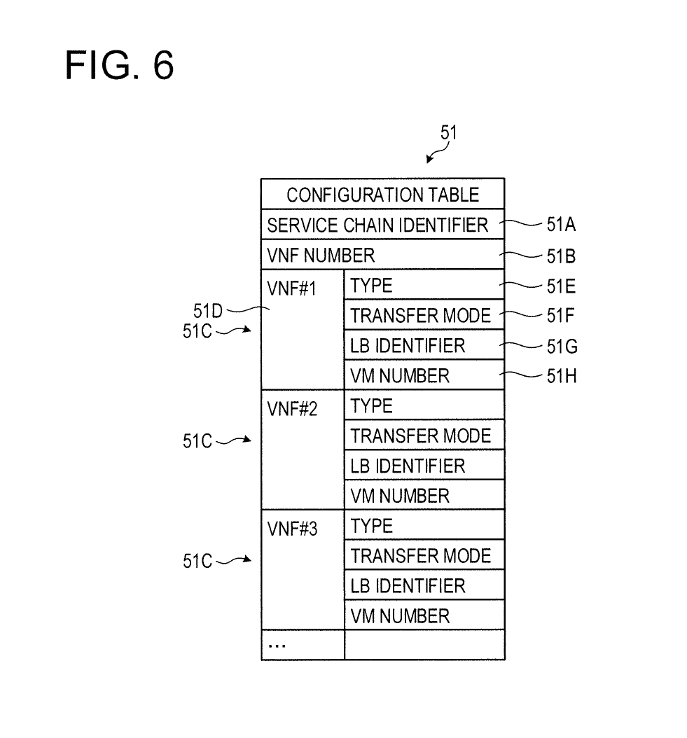

The main storage device 35 has a configuration table 51 and a VM management table 52. FIG. 6 is an explanatory view illustrating an example of a table configuration of the configuration table 51. The configuration table 51 is a table for managing arrangement information of VNFs constituting each service chain. The arrangement information has a service chain identifier 51A, a VNF number 51B, and VNF identification information 51C. The service chain identifier 51A is information for identifying a service chain. The VNF number 516 is the number of stages of VNFs constructing a service chain. The VNF identification information 51C has a VNF identifier 51D, a VNF type 51E, a transfer mode 51F, an LB identifier 51G, and a VM number 51H. The VNF identifier 51D is information for identifying a VNF in the service chain. The VNF type 51E is information for identifying the type of VNF such as LB, FW, VPN, or Cache. The transfer mode 51F is information for identifying a terminating or non-terminating VM. The terminating VM is a VM of a type that receives a traffic addressed to itself, executes an NW process to generate a traffic of a new destination, and outputs the generated traffic, for example, a VM such as LB, Cache, or Proxy. The non-terminating VM is a VM of a type that relays a traffic without changing the destination of the traffic, for example, a VM such as a VPN router or FW. The LB identifier 51G is information indicating LB or non-LB, which identifies whether a VM is LB or not. The VM number 51H is the number of VMs operating in a VNF.

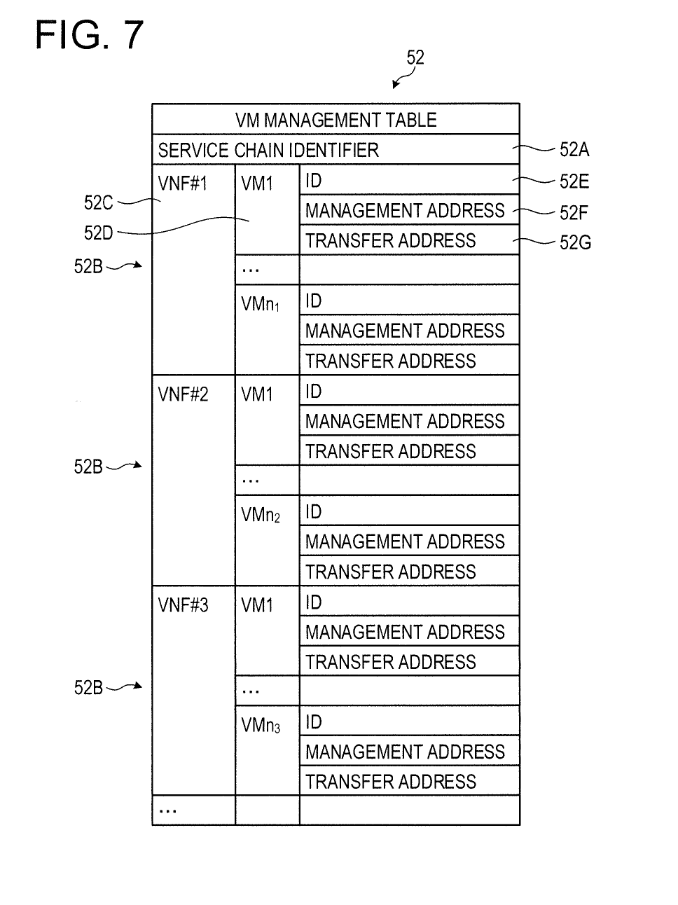

FIG. 7 is an explanatory view illustrating an example of a table configuration of the VM management table 52. The VM management table 52 is a table for managing management information of VM on the general-purpose server 2B operating as each VNF constituting each service chain. The management information has a service chain identifier 52A and VNF identification information 526. The service chain identifier 52A is information for identifying a service chain. The VNF identification information 52B is identification information for each VNF in the service chain. The VNF identification information 52B has a VNF identifier 52C and VM identification information. The VNF identifier 52C is information for identifying a VNF. The VM identification information is information for identifying a VM in the VNF. The VM identification information has a VM identifier 52D, a VMID 52E, a management address 52F, and a transfer address 52G. The VMID 52E is an ID for identifying a VM. The management address 52F is destination information for a management NW 5A with which the management server 3 communicates with a VM. The transfer address 52G is, for example, destination information for a transfer NW 5B communicating between VMs.

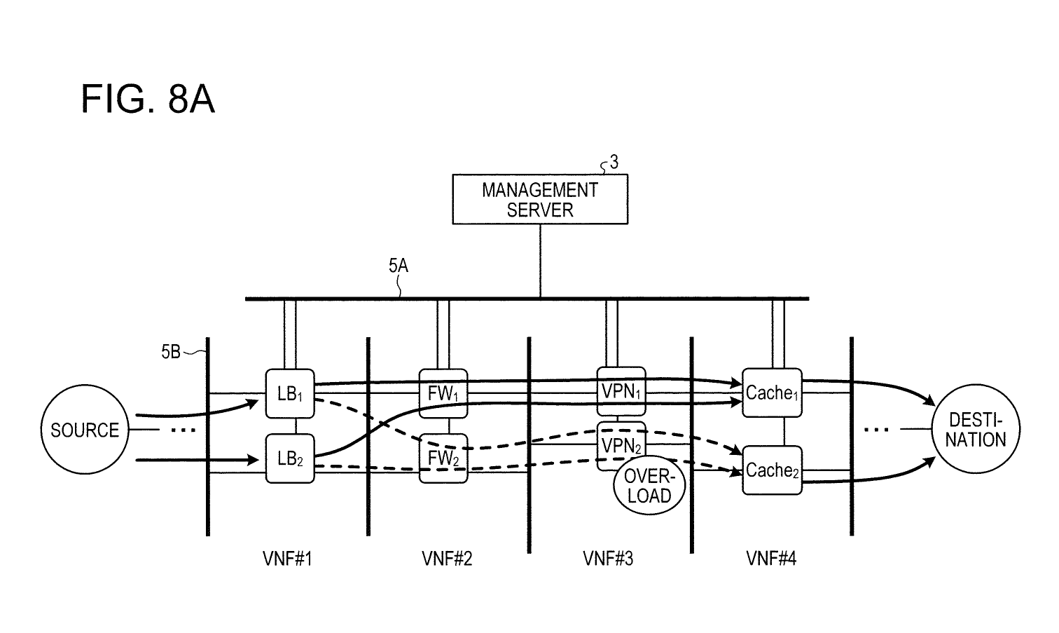

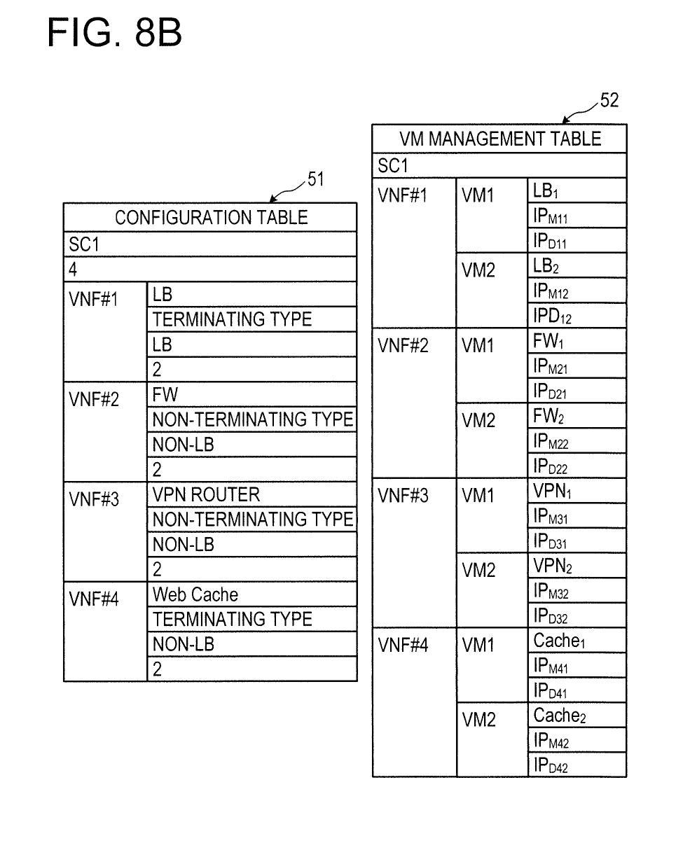

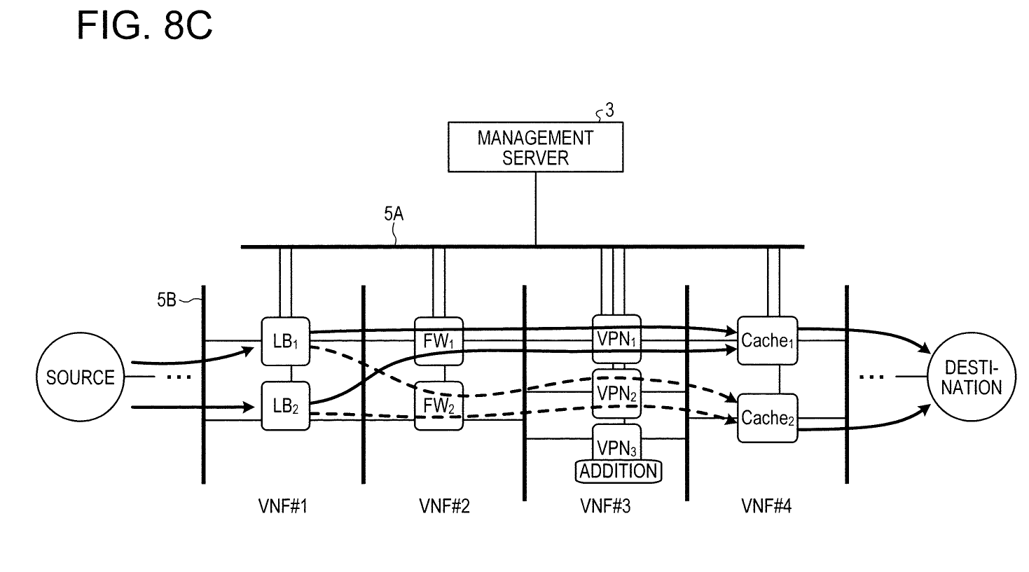

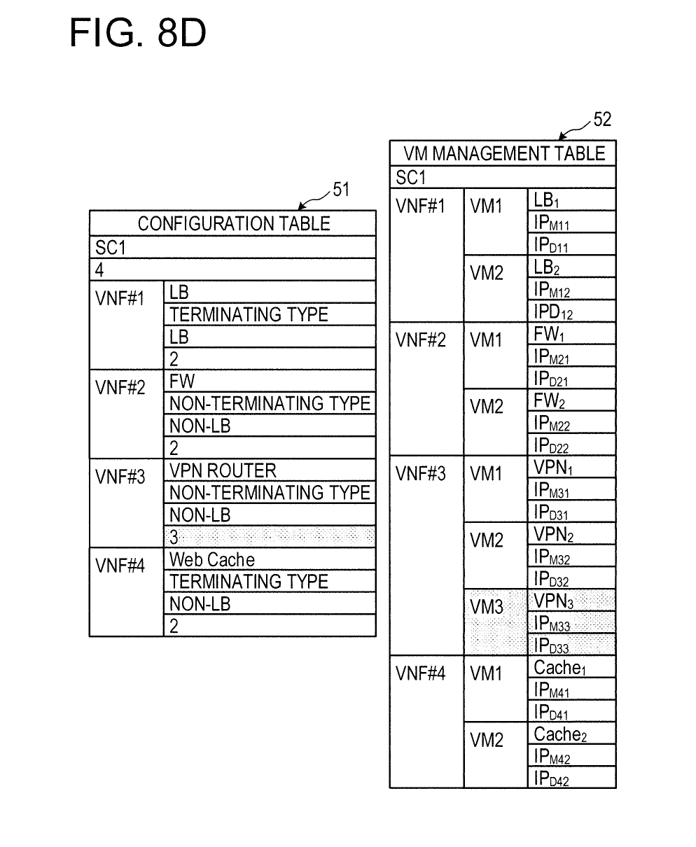

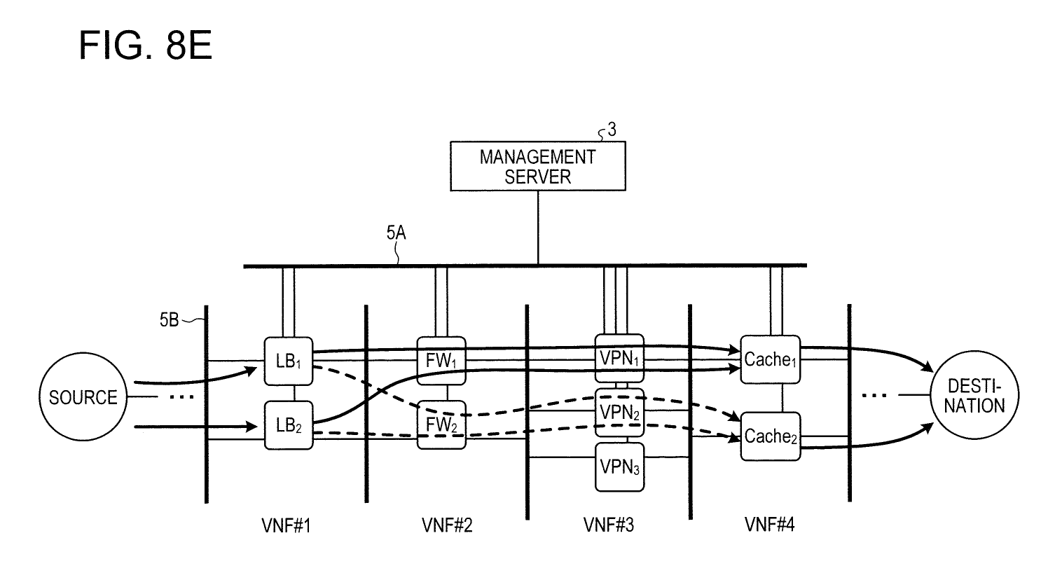

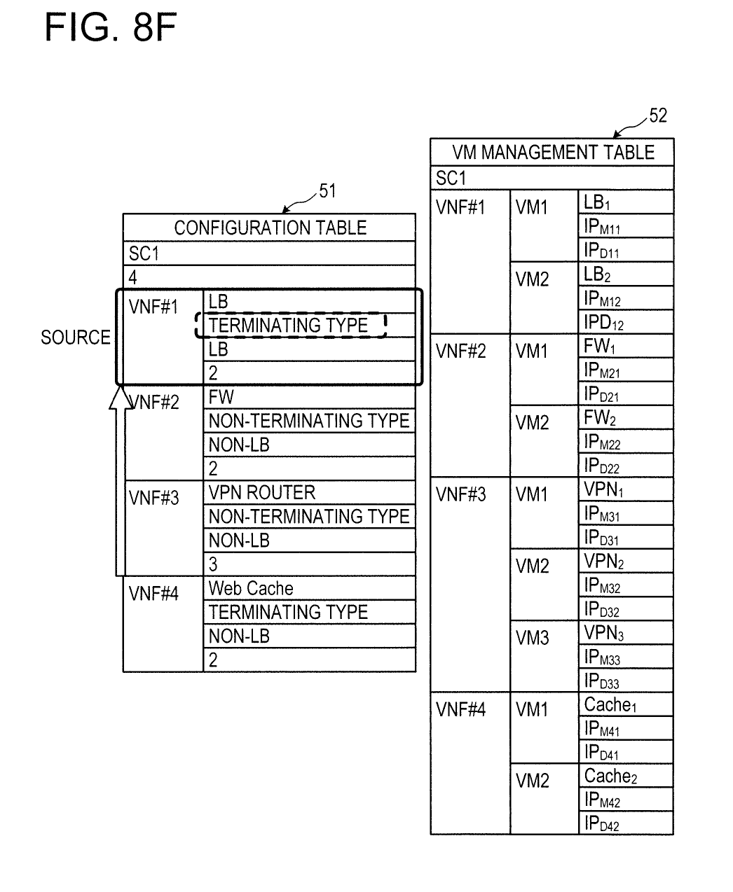

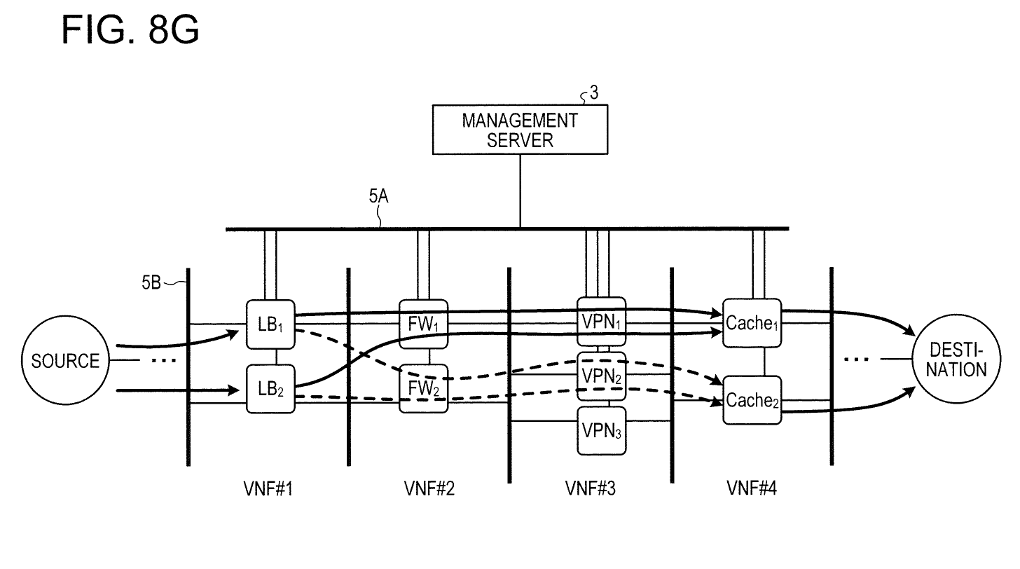

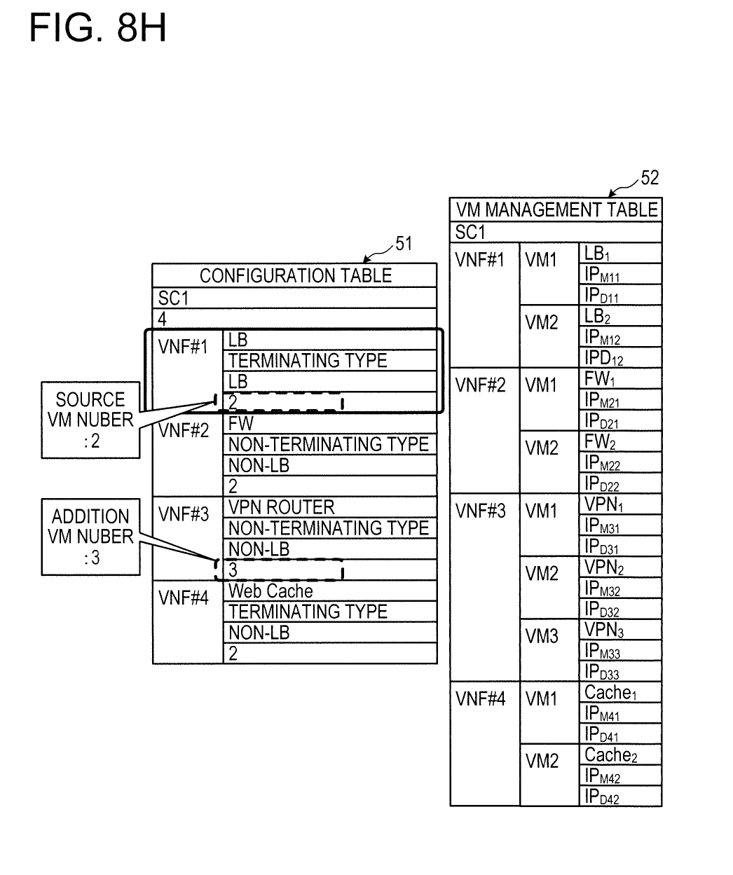

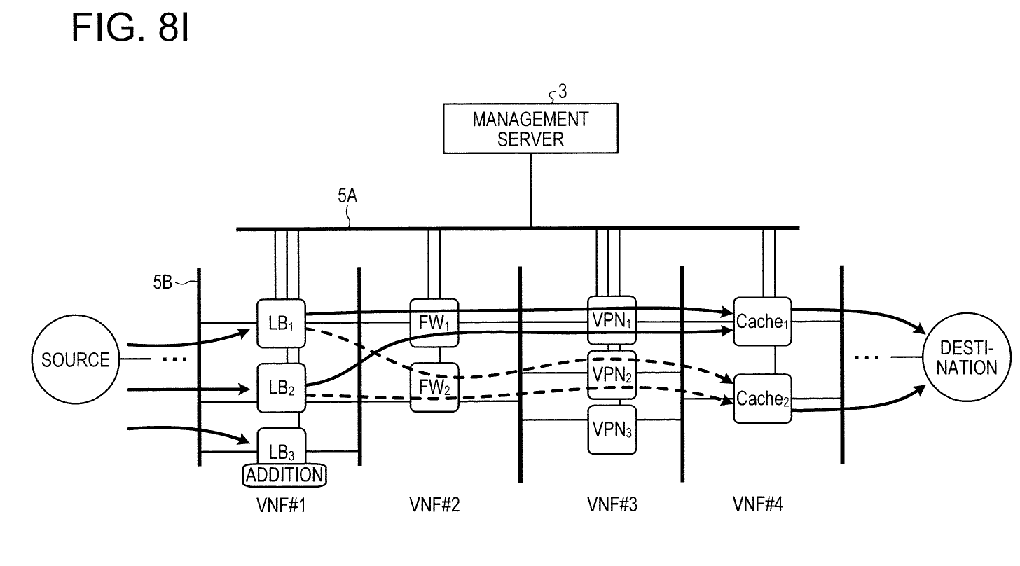

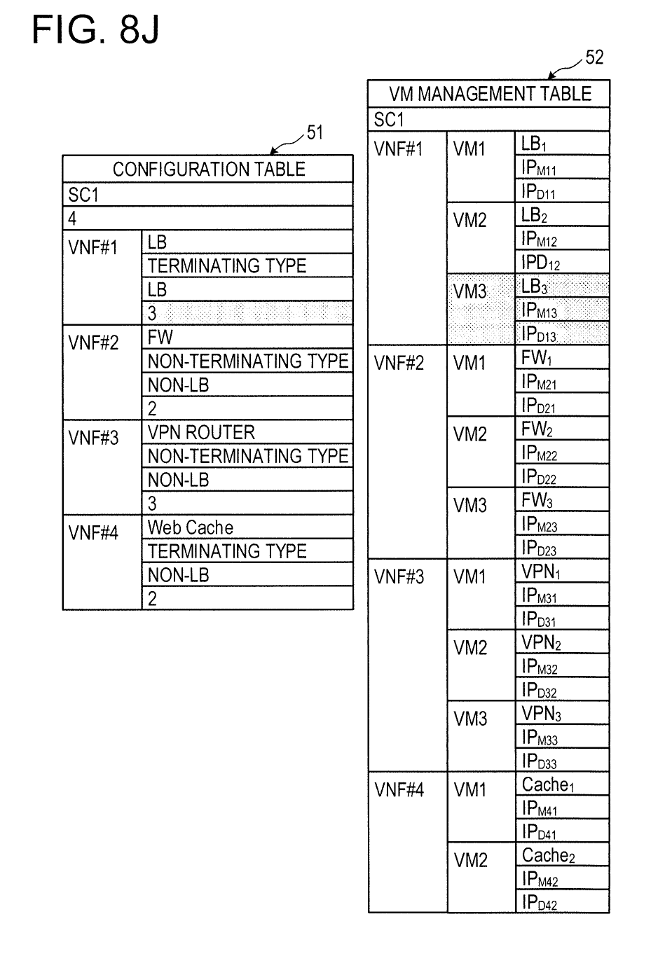

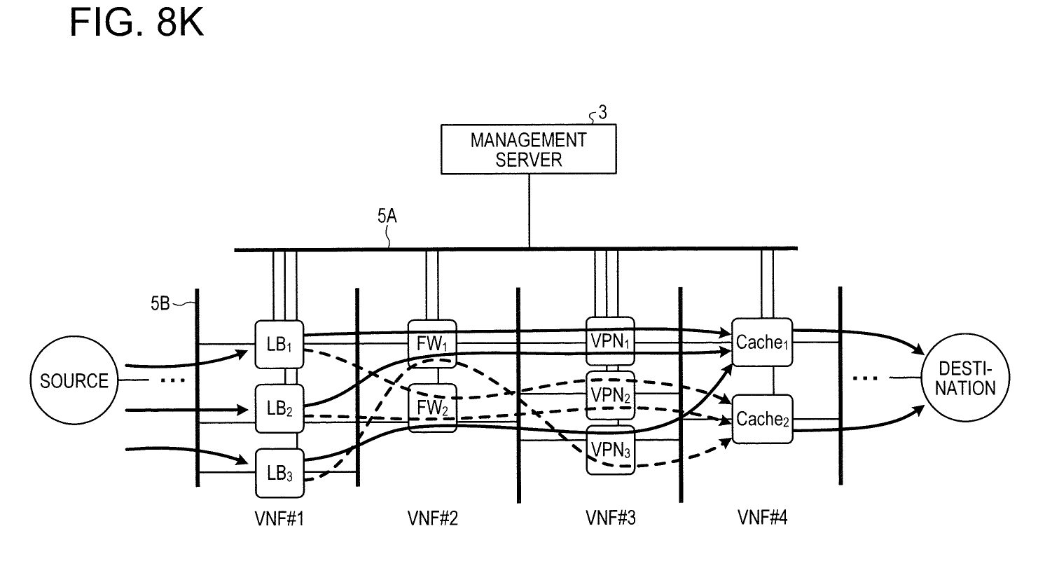

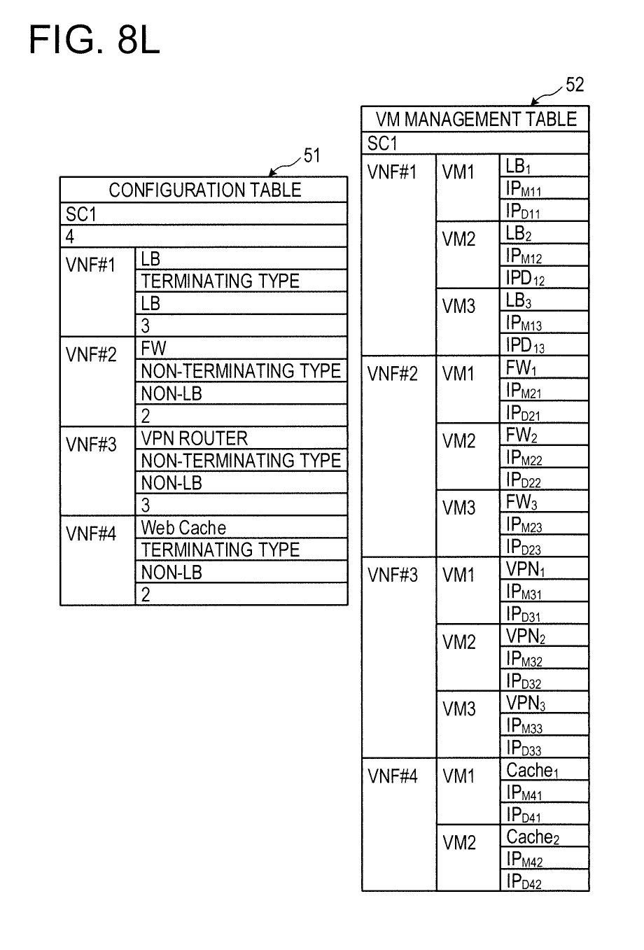

FIGS. 8A and 8B are explanatory views illustrating an example of the operation of the management server 3 at the time of detecting the overload of VNF#3 in the service chain according to the first embodiment. The service chain illustrated in FIGS. 8A and 8B are constructed by arranging VNF#1 to VNF#4 in a plurality of stages. For example, the VNF#1 has two VMs of LB₁ and LB₂ of a terminating VNF and the VNF#2 has two VMs of FW₁ and FW₂ of a non-terminating VNF. For example, the VNF#3 has two VMs of VPN₁ and VPN₂ of a non-terminating VNF and the VNF#4 has two VMs of Cache₁ and Cache₂ of a terminating VNF.

LB₁ and LB₂ assume each VM (Cache₁ and Cache₂) of the VNF#4 that terminates traffics, as a destination. LB₁ divides an input traffic into two lines of traffics and outputs each traffic to each VM (Cache₁ and Cache₂) in the destination VNF#4. LB₂ divides an input traffic into two lines of traffics and outputs each traffic to each VM (Cache₁ and Cache₂) in the destination VNF#4. VNF#1 outputs four lines of traffics to VNF#4 which becomes a destination via VNF#2 and VNF#3. In the service chain, since the total number of traffics is four lines, the traffics are distributed to all the VMs in the VNFs by controlling a transfer path.

The monitoring unit 41 in the management server 3 detects an overload of a VNF in VNF#3 as illustrated in FIGS. 8A and 8B. Upon detecting the overload of VNF#3, the monitoring unit 41 notifies the adding unit 42 of an addition request for adding a VM (VPN₃) to the overloaded VNF#3. The monitoring unit 41 periodically measures the load of each VM in the VNF in the service chain, for example, a CPU usage rate. When the CPU usage rate exceeds a predetermined threshold value, for example, 80%, the monitoring unit 41 determines that the VNF is overloaded. The monitoring unit 41 notifies the requesting unit 43 of a VNF identifier that identifies the additional VNF#3 to which the VM is added by the adding unit 42.

FIGS. 8C and 8D are explanatory views illustrating an example of the operation of the management server 3 when the VM of VNF#3 is added. As illustrated in FIGS. 8C and 8D, the adding unit 42 in the management server 3 adds the third VPN₃ to VNF#3 in response to the addition request from the monitoring unit 41. The control unit 45 changes the VM number 51H corresponding to the additional VNF#3 in the configuration table 51 to “3”. The control unit 45 adds the VM identifier 52D, the VMID 52E, the management address 52F, and the transfer address 52G as the VM identification information of the VPN₃ corresponding to the additional VNF#3 in the VM management table 52.

FIGS. 8E and 8F are explanatory views illustrating an example of the operation of the management server 3 when a source VNF is specified. As illustrated in FIGS. 8E and 8F, the specifying unit 43A in the requesting unit 43 in the management server 3 refers to the configuration table 51 to specify a source VNF as a source address of a traffic passing through the additional VNF. For example, the specifying unit 43A specifies an LB in the source VNF#1 of the terminating VNF of a traffic passing through the additional VNF#3.

FIGS. 8G and 8H are explanatory views illustrating an example of the operation of the management server 3 at the time of extracting the number of source VMs and the number of additional VMs. As illustrated in FIGS. 8G and 8H, the requesting unit 43 compares the number of VMs of the additional VNF, that is, the number of additional VMs, with the number of VMs of the source VNF, that is, the number of source VMs. When the number of source VMs is smaller, the requesting unit 43 notifies the adding unit 42 of an addition request to add a VM to the source VNF so that the number of source VMs is equal to or larger than the number of additional VMs. For example, since the number of source VMs of the source VNF#1 is two and the number of additional VMs of the additional VNF#3 is three, the requesting unit 43 notifies the adding unit 42 of an addition request to add one VM (LB₃) to the source VNF#1.

FIGS. 8I and 8J are explanatory views illustrating an example of the operation of the management server 3 at the time of adding a VM of the source VNF#1. In response to an addition request from the requesting unit 43, the adding unit 42 adds a VM (LB₃) to the source VNF#1 as illustrated in FIGS. 8I and 8J. The control unit 45 changes the VM number 51H corresponding to the source VNF#1 in the configuration table 51 to “3”. The control unit 45 adds the VM identifier 52D, the VMID 52E, the management address 52F, and the transfer address 52G as the VM identification information of the LB₃ corresponding to the source VNF#1 in the VM management table 52. Then, the adding unit 42 requests the resetting unit 44 for a transfer path and an allocation setting.

FIGS. 8K and 8L are explanatory views illustrating an example of the operation of the management server 3 at the time of resetting path. As illustrated in FIGS. 8K and 8L, the resetting unit 44 in the management server 3 recalculates an allocation setting of LB and a transfer path of each VM in order to allocate traffics to all the VMs including the additional VM, and sets the recalculated allocation setting in each LB and the recalculated transfer path in each VM. As a result, the service chain is reestablished. Upon detecting the overload of VNF#3, the management server 3 may allocate traffics to all the VMs since the management server 3 adds a VPN and also adds an LB of the source VNF#1 in conjunction. Then, since the management server 3 may distribute the traffics to all VMs, the processing load of the overloaded VNF#3 may be reduced.

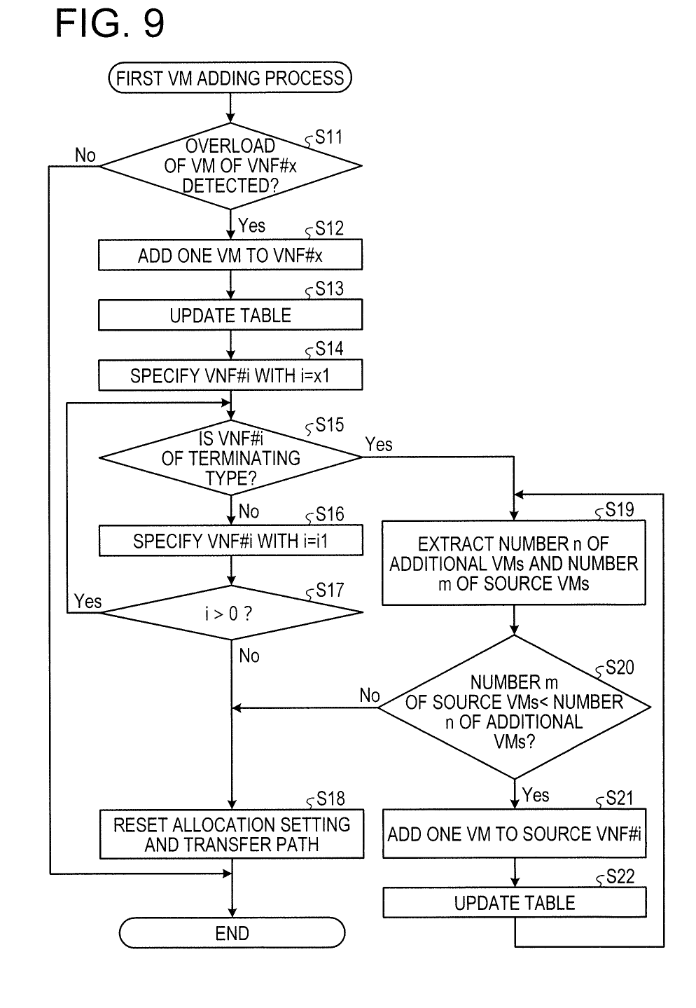

FIG. 9 is a flowchart illustrating an example of the processing operation of the processor 36 in the management server 3 related to a first VM adding process. Referring to FIG. 9, the monitoring unit 41 in the processor 36 determines whether or not an overload of VNF#x in the service chain has been detected (Operation S11). When an overload of VNF#x has been detected (“Yes” in Operation S11), the monitoring unit 41 notifies the adding unit 42 of an addition request to add a VM to VNF#x. In response to the addition request, the adding unit 42 in the processor 36 adds one VM to the overloaded VNF#x (Operation S12). The control unit 45 in the processor 36 updates the configuration table 51 and the VM management table 52 according to the additional VM for the additional VNF (Operation S13).

Furthermore, the specifying unit 43A in the requesting unit 43 in the processor 36 refers to the VNF identifier 51D of the configuration table 51 to specify VNF#i at the previous stage of VNF#x with x−1=i, that is, at the transmitting side (Operation S14). The specifying unit 43A refers to the transfer mode 51F of the configuration table 51 to determine whether or not VNF#i is of a terminating type (Operation S15).

When VNF#i is not of a terminating type (“No” in Operation S15), the specifying unit 43A refers to the VNF identifier 51D of the configuration table 51 to specify VNF#i at the previous stage with i=i−1 (Operation S16). The specifying unit 43A determines whether or not i is greater than 0 (Operation S17). When it is determined that i is greater than 0 (“Yes” in Operation S17), the requesting unit 43 proceeds to Operation S15 to determine whether or not VNF#i specified in Operation S16 is of a terminating type.

When it is determined that i is not greater than 0 (“No” in Operation S17), the resetting unit 44 in the processor 36 resets the allocation setting of LB and the transfer path of each VM so that the traffics are distributed to all the VMs including the additional VM (Operation S18), and then ends the processing operation illustrated in FIG. 9.

When it is determined that VNF#i is of a terminating type (“Yes” in Operation S15), the requesting unit 43 refers to the VM number 51H in the configuration table 51 to extract the number n of additional VMs of the additional VNF#x and the number m of source VMs of the source VNF#i (Operation S19). The requesting unit 43 determines whether or not the number m of source VMs is smaller than the number n of additional VMs (Operation S20).

When it is determined that the number m of source VMs is smaller than the number n of additional VMs (“Yes” in Operation S20), the requesting unit 43 notifies the adding unit 42 of an addition request to add a VM to the source VNF#i. In response to the addition request from the requesting unit 43, the adding unit 42 adds one VM to the source VNF#i (Operation S21). The control unit 45 updates the configuration table 51 and the VM management table 52 according to the additional VM for the source VNF (Operation S22). Further, the requesting unit 43 proceeds to Operation S19 to extract the number of additional VMs and the number of source VMs in accordance with table update of the additional VM for the source VNF.

When it is determined that the number m of source VMs is not smaller than the number n of additional VMs (“No” in Operation S20), the requesting unit 43 proceeds to Operation S18 to reset the allocation setting of LB and the transfer path of each VM so that the traffics are distributed to all the VMs including the additional VM. Further, when it is determined that the overload of VNF#x has not been detected (“No” in Operation S11), the monitoring unit 41 ends the processing operation illustrated in FIG. 9.

When adding a VM to the overloaded VNF, the management server 3 of the first embodiment specifies a source VNF of a traffic passing through the additional VNF. The management server 3 adds the VM to the source VNF so that the traffics may be allocated to all the VMs in the additional VNF. As a result, even when the VM is added to the overloaded VNF, since the management server 3 may reliably allocate the traffics to all the VMs, the processing load of the overloaded VNF may be reduced while distributing the traffics to all the VMs.

The management server 3 adds a virtual machine to a source VNF according to the number of additional VMs of all the VMs in the additional VNF. As a result, the management server 3 may allocate traffics to all VMs.

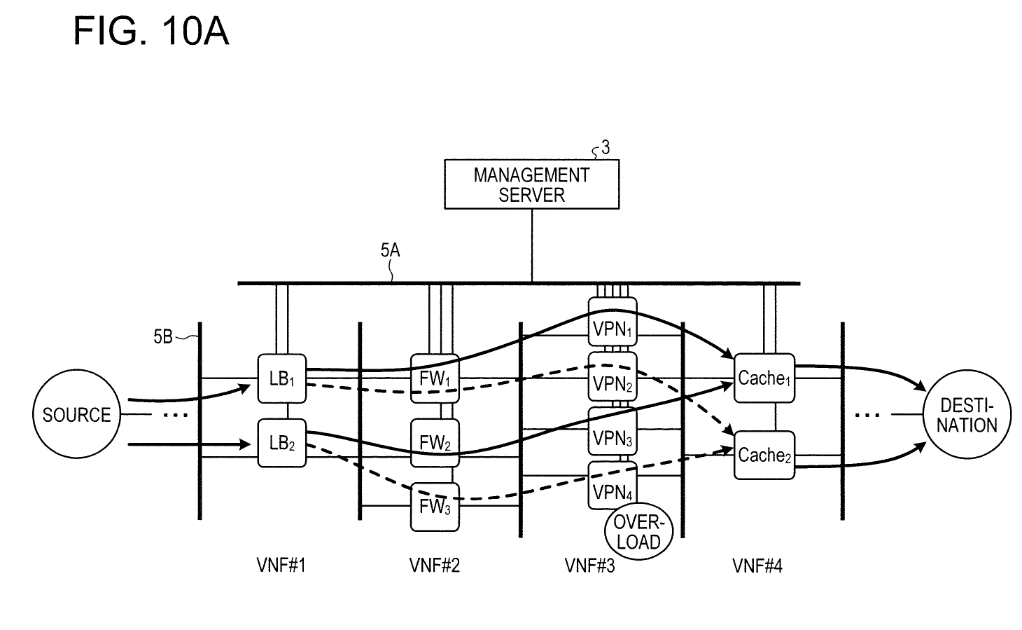

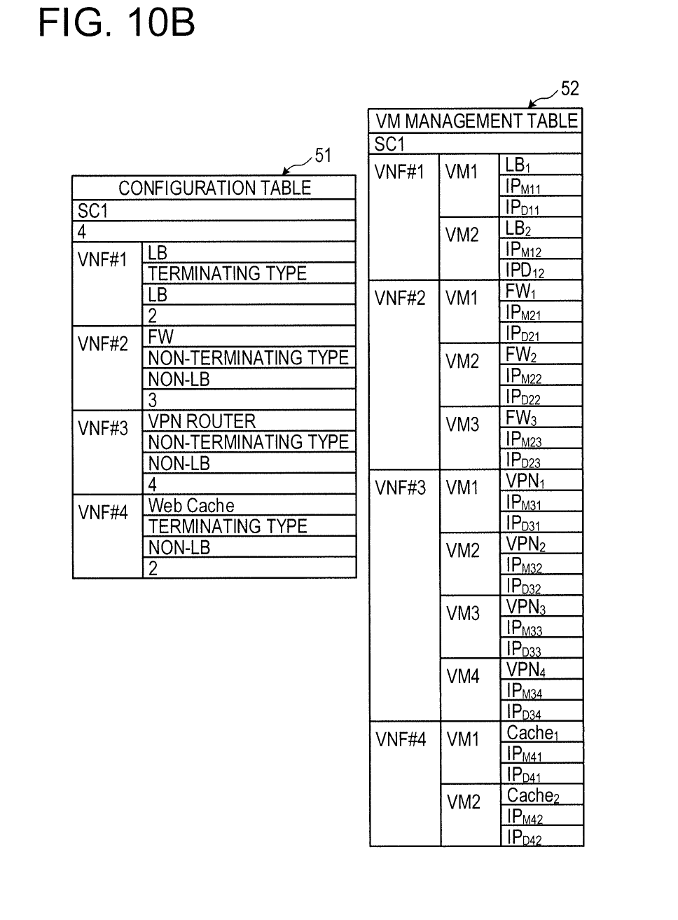

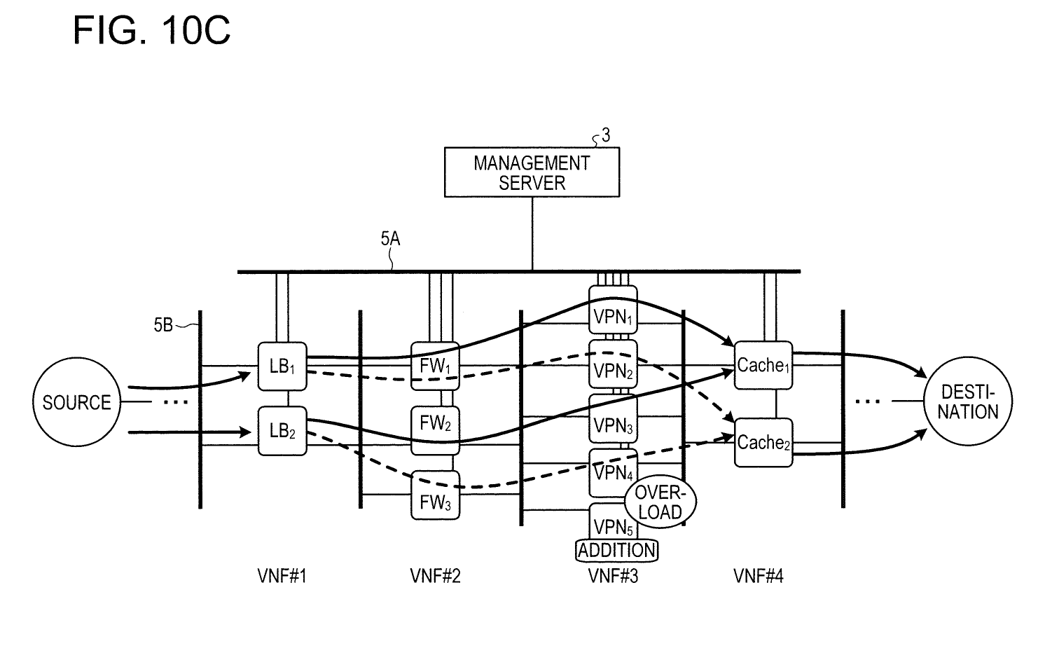

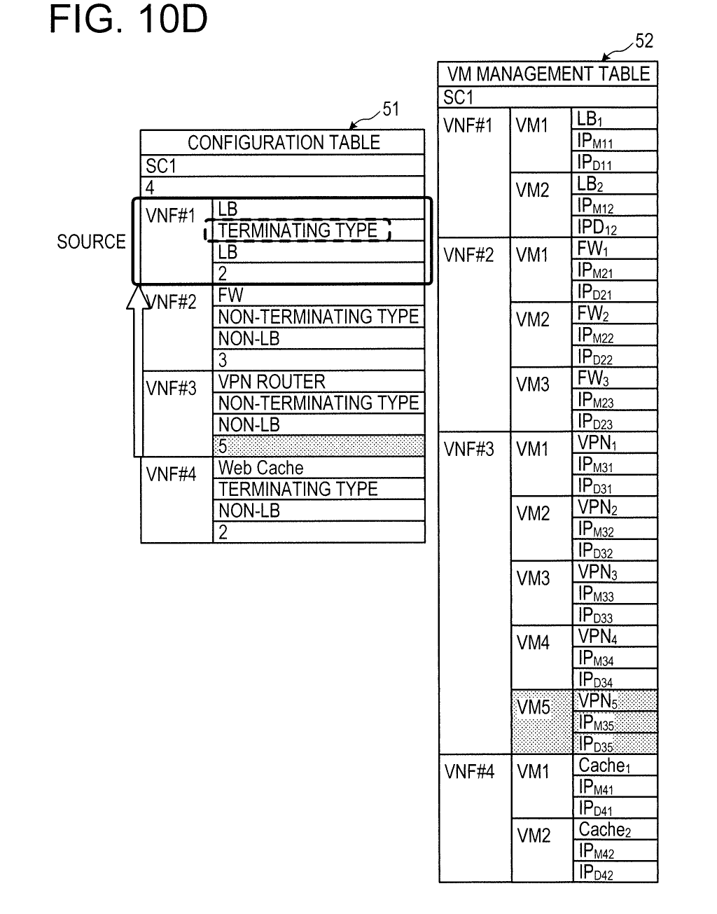

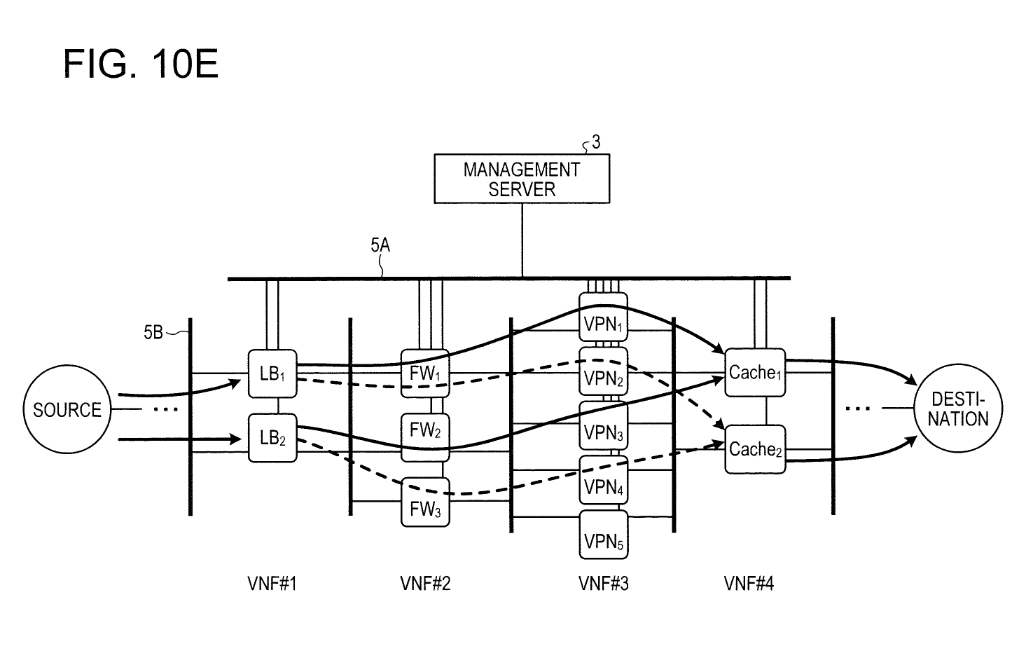

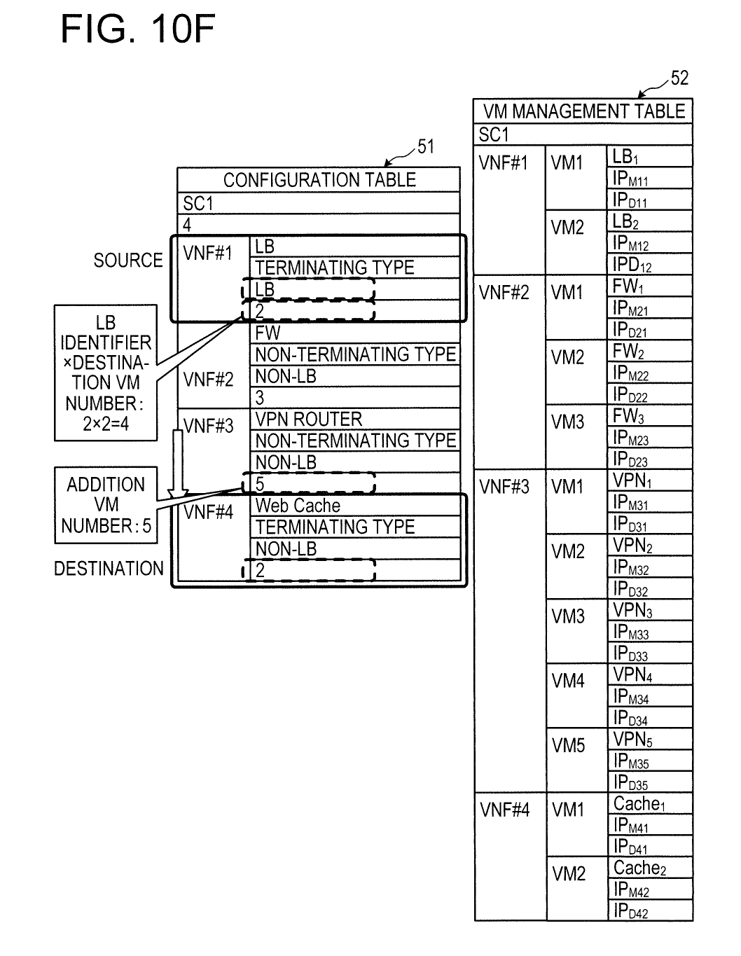

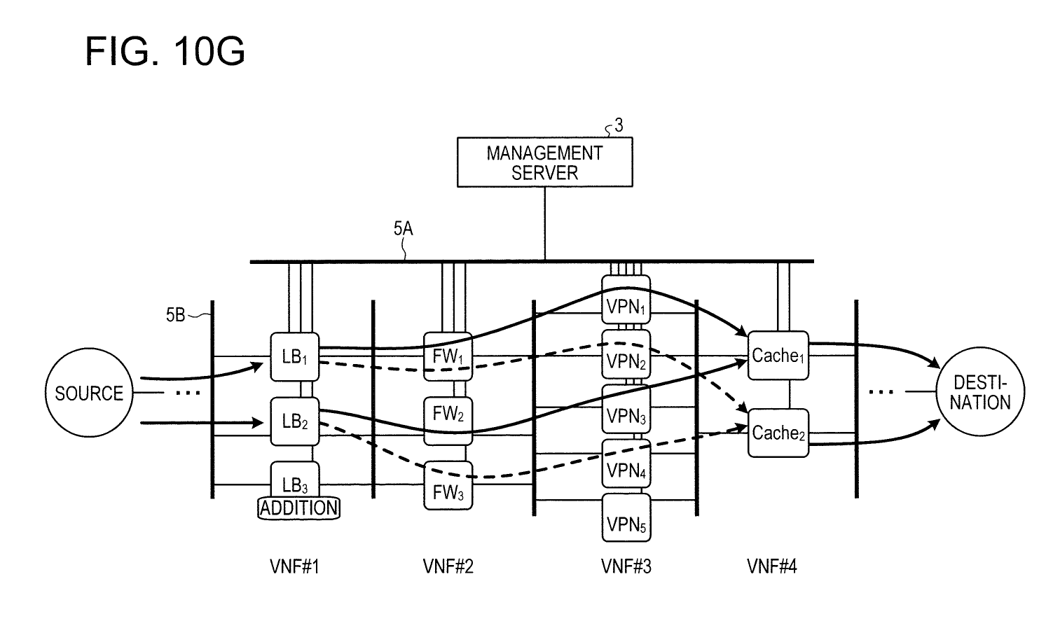

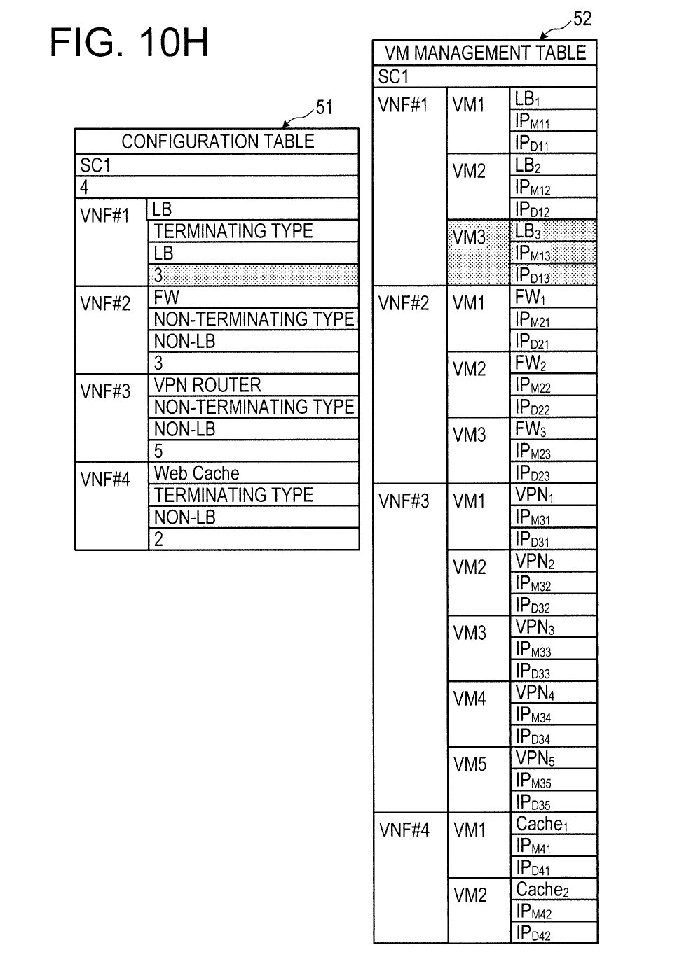

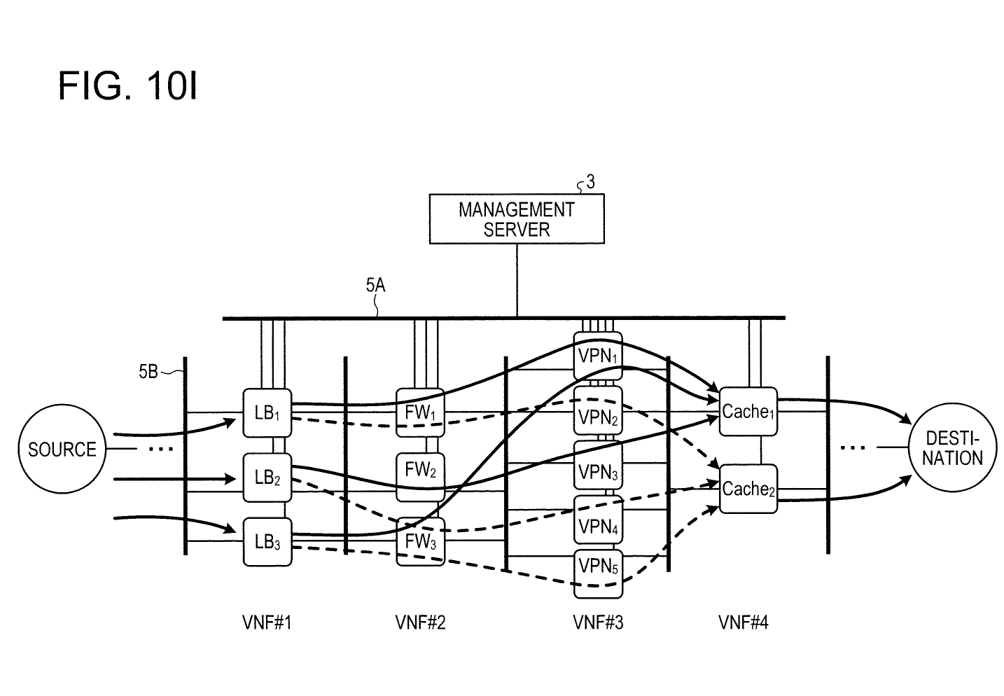

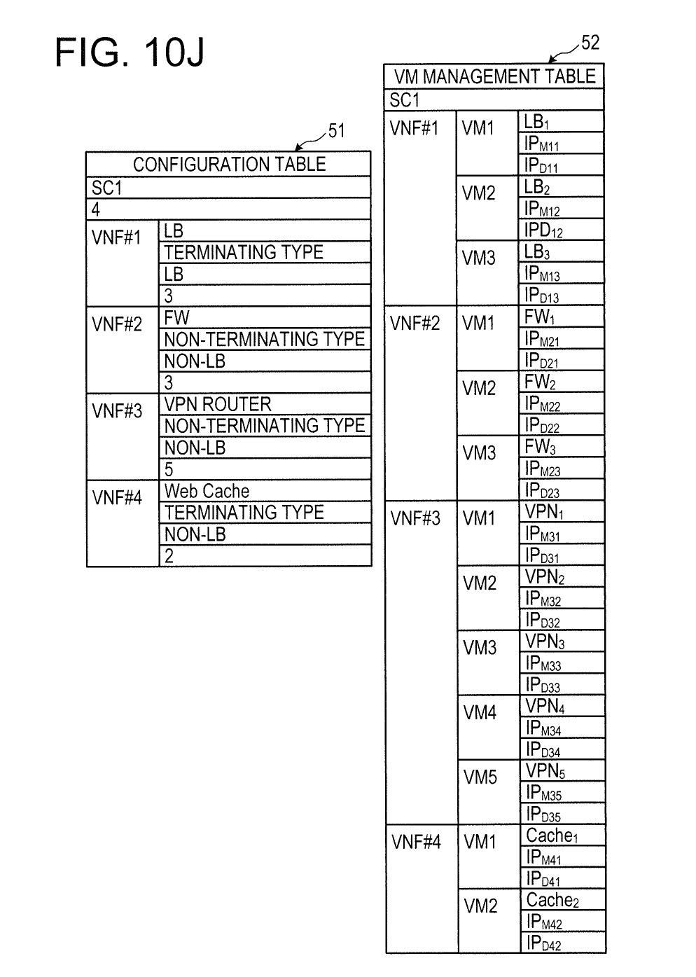

In the first embodiment, even when a VM is added, a VM is added to a source VNF so that traffics may be allocated to all VMs including the additional VM. However, this embodiment is not limited to such a configuration but may be appropriately modified. A second embodiment in which a VM is added to a source VNF based on a result of determination as to whether or not the source VNF is LB will be described below. FIGS. 10A and 10B are explanatory views illustrating an example of the operation of the management server 3 when detecting an overload of VNF#3 in a service chain according to a second embodiment. In the second embodiment, the same configurations as those in the service chain system of the first embodiment are denoted by the same reference numerals and explanation on the overlapping configuration and operation thereof will not be repeated.

### Second Embodiment

The service chain illustrated in FIGS. 10A and 10B is constructed by arranging VNF#1 to VNF#4 in a plurality of stages. For example, VNF#1 has two VMs of LB₁ and LB₂ of a terminating VNF and VNF#2 has three VMs of FW₁ to FW₃ of a non-terminating VNF. For example, VNF#3 has four VMs of VPN₁ to VPN₄ of a non-terminating VNF and VNF#4 has two VMs of Cache₁ and Cache₂ of a terminating VNF.

LB₁ and LB₂ assume each VM (Cache₁ and Cache₂) that terminates traffics, as a destination. LB₁ divides an input traffic into two lines of traffics and outputs each traffic to each VM (Cache₁ and Cache₂) in the destination VNF#4. LB₂ divides an input traffic into two lines of traffics and outputs each traffic to each VM (Cache₁ and Cache₂) in the destination VNF#4. VNF#1 outputs four lines of traffics to VNF#4 as a destination VNF via VNF#2 and VNF#3. In the service chain illustrated in FIGS. 10A and 10B, since the total number of traffics is four lines, the traffics are distributed to all the VMs passing through a transfer path by controlling the transfer path.

Upon detecting the overload of a VPN in VNF#3, the monitoring unit 41 notifies the adding unit 42 of an addition request to add a VM (VPN₅) to the overloaded VNF#3. The monitoring unit 41 notifies the requesting unit 43 of a VNF identifier that identifies the additional VNF#3.

FIGS. 10C and 10D are explanatory views illustrating an example of the operation of the management server 3 at the time of adding a VM of VNF#3 and specifying a source VNF. As illustrated in FIGS. 10C and 10D, the adding unit 42 adds the fifth VPN₅ to VNF#3 in response to the addition request from the monitoring unit 41. The control unit 45 changes the VM number 51H corresponding to the additional VNF#3 in the configuration table 51 to “5”. The control unit 45 adds the VM identifier 52D, the VMID 52E, the management address 52F, and the transfer address 52G as the VM identification information of VPN₅ corresponding to the additional VNF#3 in the VM management table 52.

The specifying unit 43A refers to the transfer mode 51F in the configuration table 51 to specify a terminating source VNF of a traffic passing through the additional VNF. The requesting unit 43 refers to the LB identifier 51G in the configuration table 51 to determine whether or not the source VNF is LB. When the source VNF is LB, the requesting unit 43 determines whether or not the additional VM may allocate a traffic. When the additional VM may allocate a traffic, the requesting unit 43 compares the number of VMs of the additional VNF, that is, the number of additional VMs, with the number of VMs of the source VNF, that is, the number of source VMs. When the source VNF is not LB, the requesting unit 43 compares the number of source VMs with the number of additional VMs to determine whether or not the additional VM may allocate a traffic.

The determination as to whether or not a traffic may be allocated to the additional VM is made based on the number of traffics passing through a VNF including the additional VM. When the number of traffics is larger than the number of VMs of the additional VNF including the additional VM, a traffic may be allocated to the additional VM by controlling transfer paths of these traffics. When the source VNF is LB, the number of traffics may be calculated as “the number of pairs of the number of LBs and the number of destination VMs of the destination VNF”.

FIGS. 10E and 10F are explanatory views illustrating an example of the operation of the management server 3 at the time of extracting the number of source VMs, the number of additional VMs, and the number of destination VMs. As illustrated in FIGS. 10E and 10F, the requesting unit 43 refers to the VM number 51H in the configuration table 51 to extract the number of source VMs and the number of destination VMs, and multiplies the number of source VMs by the number of destination VMs to calculate the number of traffics. In addition, the requesting unit 43 refers to the configuration table 51 to specify a terminating VNF of the next stage on the destination side from the additional VNF as a destination VNF, and extracts the number of VMs of the destination VNF as the number of destination VMs. The destination VNF is Cache₁ and Cache₂ of VNF#4 in the case of FIGS. 10E and 10F. The requesting unit 43 multiplies the number of source VMs “2” by the number of destination VMs “2” to calculate the number of traffics “2×2=4”.

The requesting unit 43 compares the calculated number of traffics with the number of additional VMs. When the number of additional VMs is larger than the number of traffics, the requesting unit 43 determines that no traffic may be allocated to the additional VM. In the example of FIGS. 10E and 10F, since the number of pairs of two LBs and two destination VMs is 4 and the number of additional VMs is 5, a traffic may not be allocated to the additional VM.

The requesting unit 43 notifies the adding unit 42 of an addition request to add a VM to the source VNF so that the number of traffics becomes equal to or larger than the number of additional VMs of the additional VNF.

FIGS. 10G and 10H are explanatory views illustrating an example of the operation of the management server 3 at the time of adding a VM to the source VNF#1. In response to the addition request from the requesting unit 43, the adding unit 42 adds a VM (LB₃) to the source VNF#1 as illustrated in FIG. 10D. The control unit 45 changes the VM number 51H corresponding to the source VNF#1 in the configuration table 51 to “3”. The control unit 45 adds the VM identifier 52D, the VMID 52E, the management address 52F, and the transfer address 52G as the VM identification information of LB₃ corresponding to the source VNF#1 in the VM management table 52. Then, the adding unit 42 requests the resetting unit 44 for a transfer path and an allocation setting.

FIG. 10E is an explanatory view illustrating an example of the operation of the management server 3 at the time of resetting path. As illustrated in FIG. 10E, the resetting unit 44 in the management server 3 recalculates an allocation setting of LB and a transfer path of each VM in order to allocate traffics to all additional VMs, and sets the recalculated allocation setting in each LB and the recalculated transfer path in each VM. As a result, the service chain is reestablished. Upon detecting the overload of VPN of VNF#3, the management server 3 may allocate traffics to all additional VPMs since the management server 3 adds a VPN and also adds an LB in conjunction. Then, since the management server 3 is able to distribute the traffics to all VMs, the processing load of the overloaded VNF#3 may be reduced.

When adding a VM to the overloaded VNF, the management server 3 specifies a source VNF of a traffic passing through the additional VNF. The management server 3 calculates the number of traffics by multiplying the number of source VMs of the source VNF by the number of destination VMs of the destination VNF. When the source VNF is LB and the number of traffics is smaller than the number of additional VMs, the management server 3 adds an LB to the source VNF. As a result, even when a VM is added to the overloaded VNF, since the management server 3 may reliably allocate the traffics to all the VMs, the processing load of the overloaded VNF may be reduced while distributing the traffics to all the VMs.

When the source VNF is LB and the number of traffics is equal to or larger than the number of additional VMs, the management server 3 may suppress wasteful addition of LB to the source VNF and reliably allocate the traffics to all VMs by controlling a transfer path. As a result, the processing load of the overloaded VNF may be reduced while distributing the traffics to all VMs.

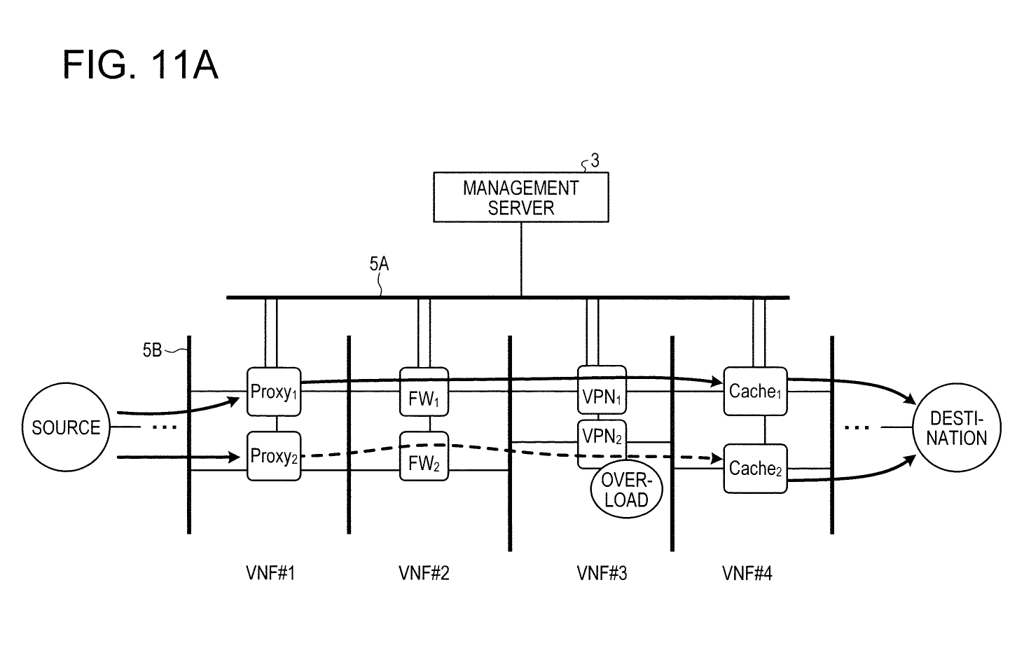

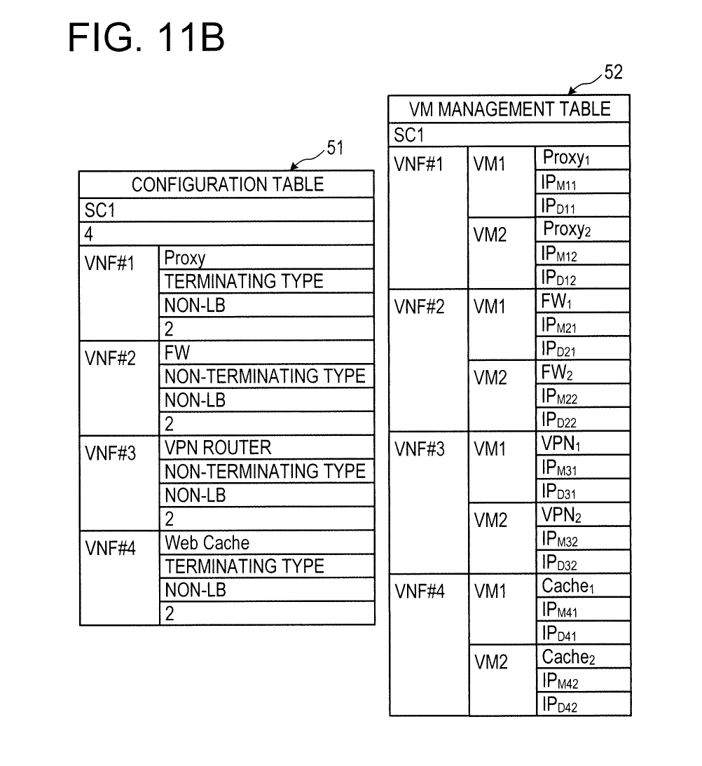

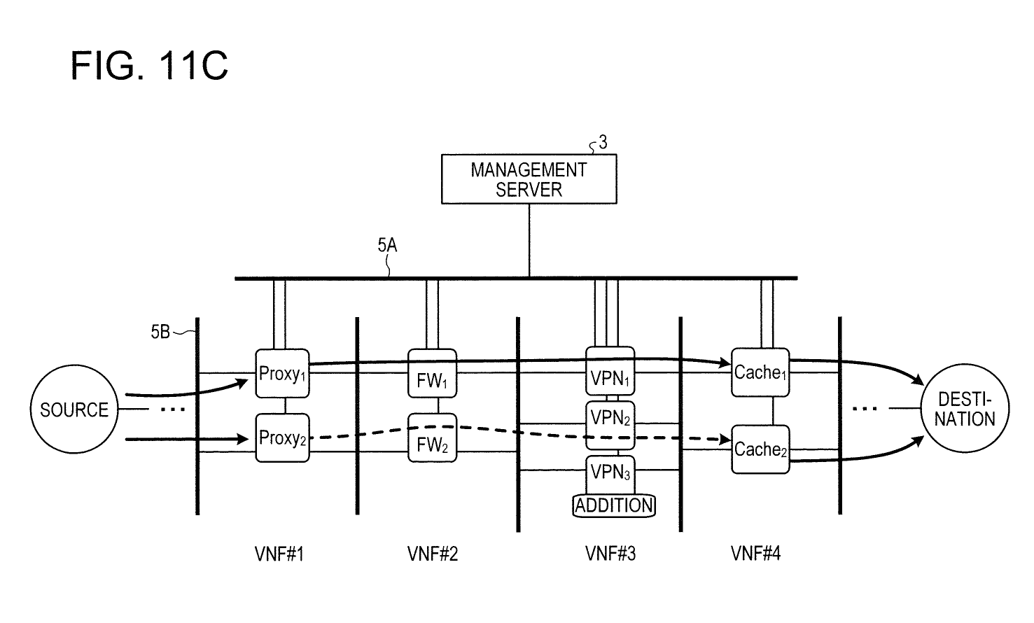

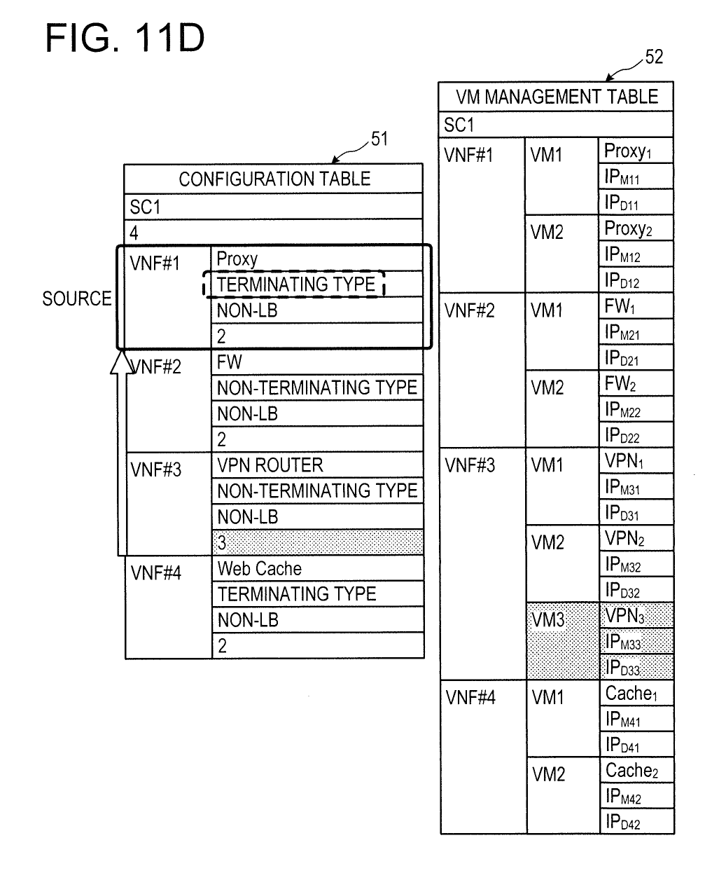

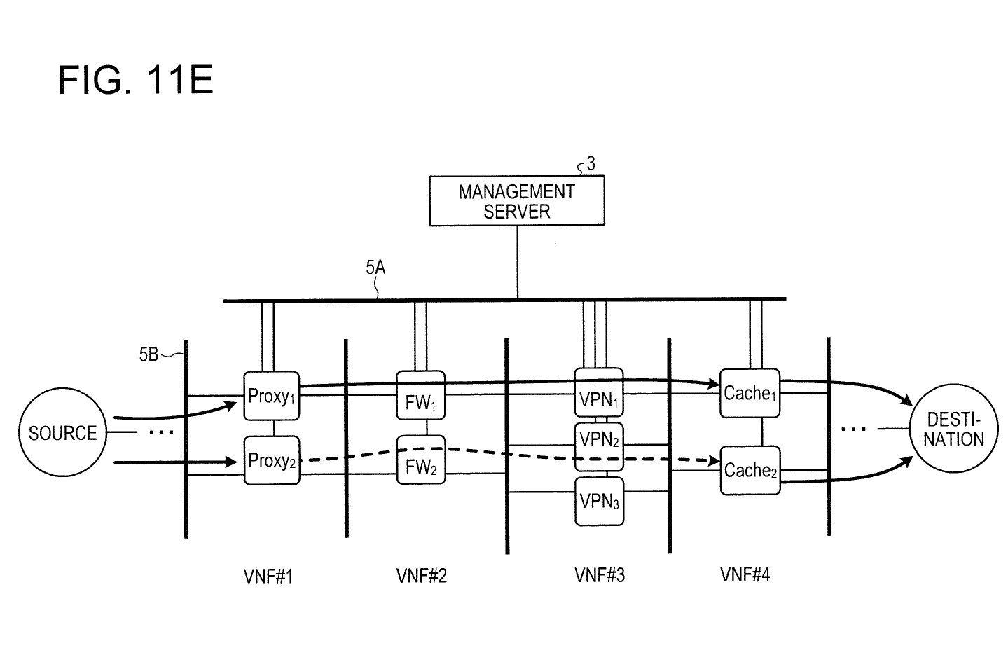

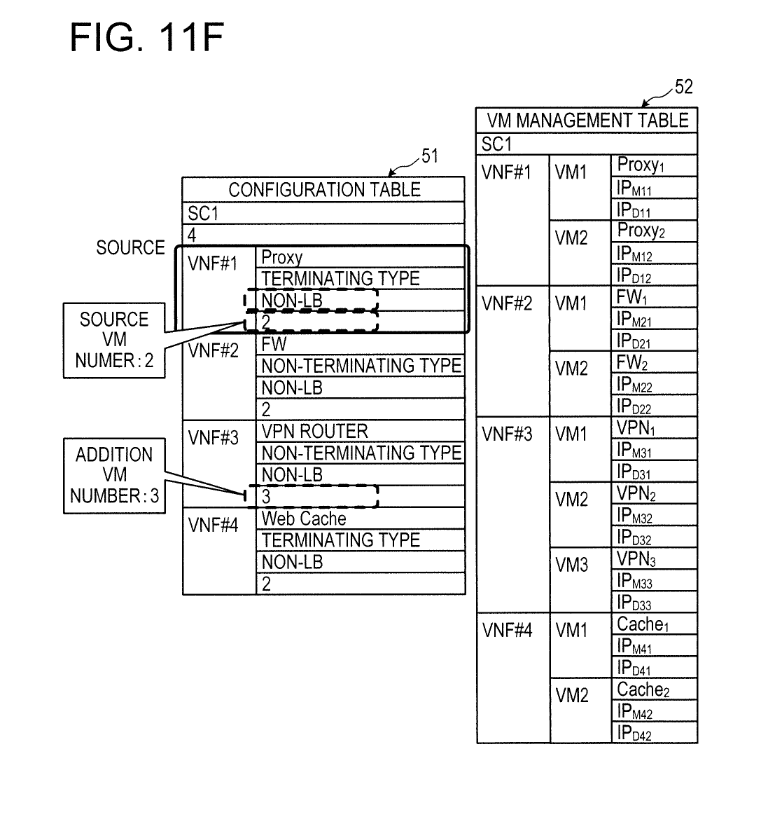

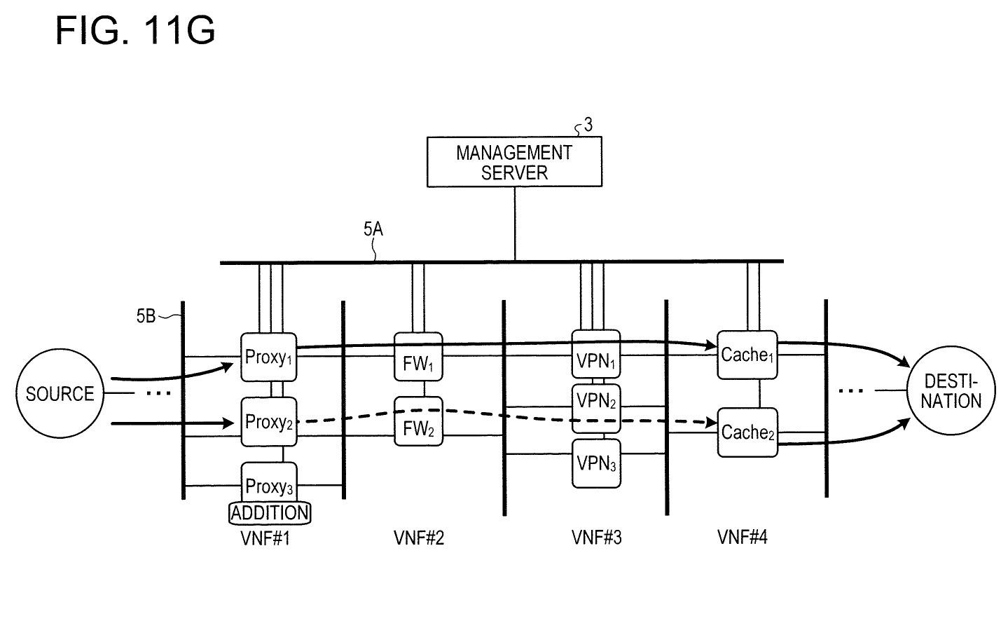

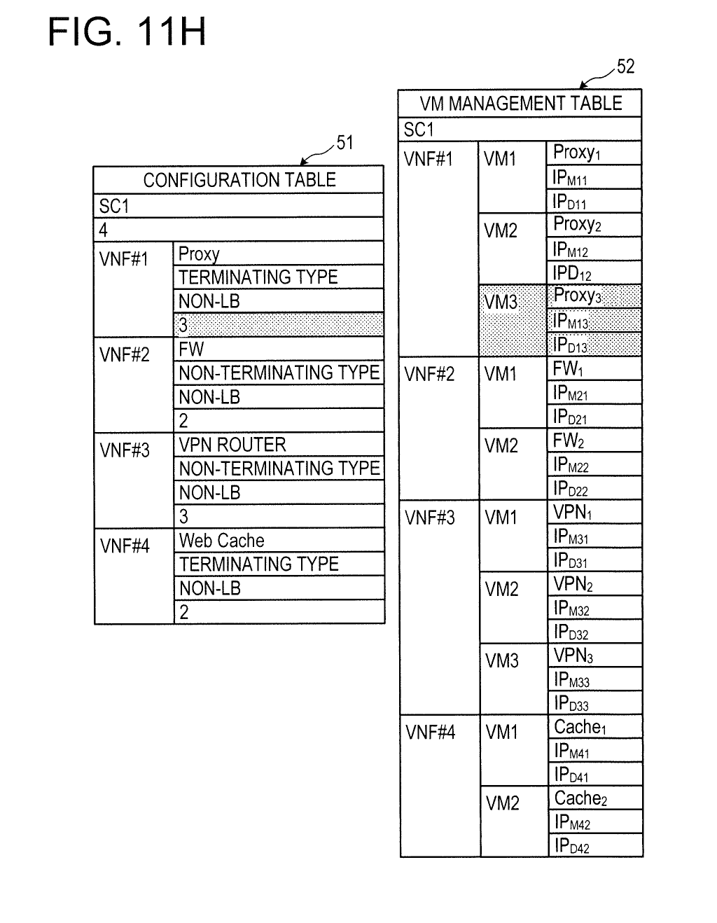

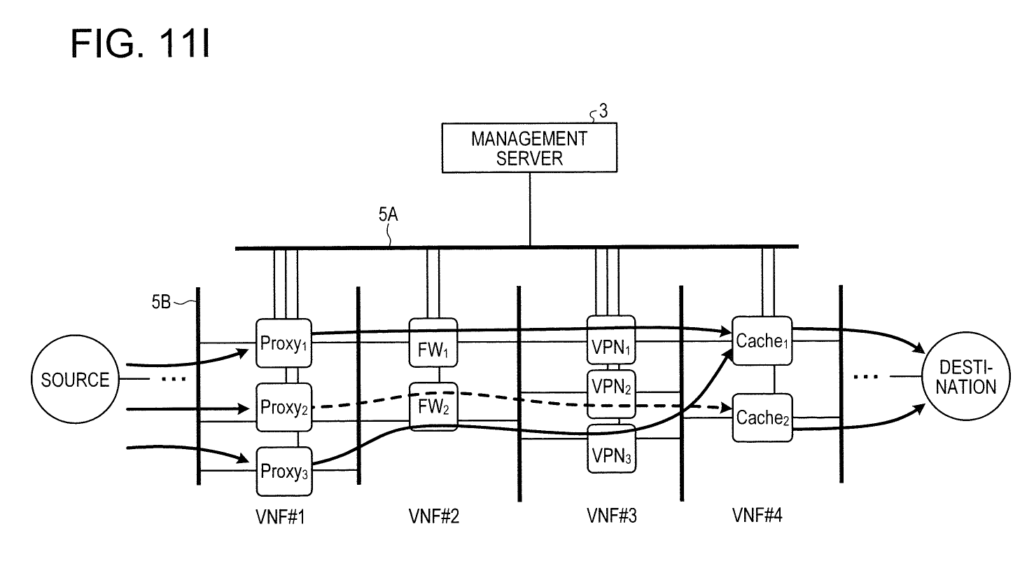

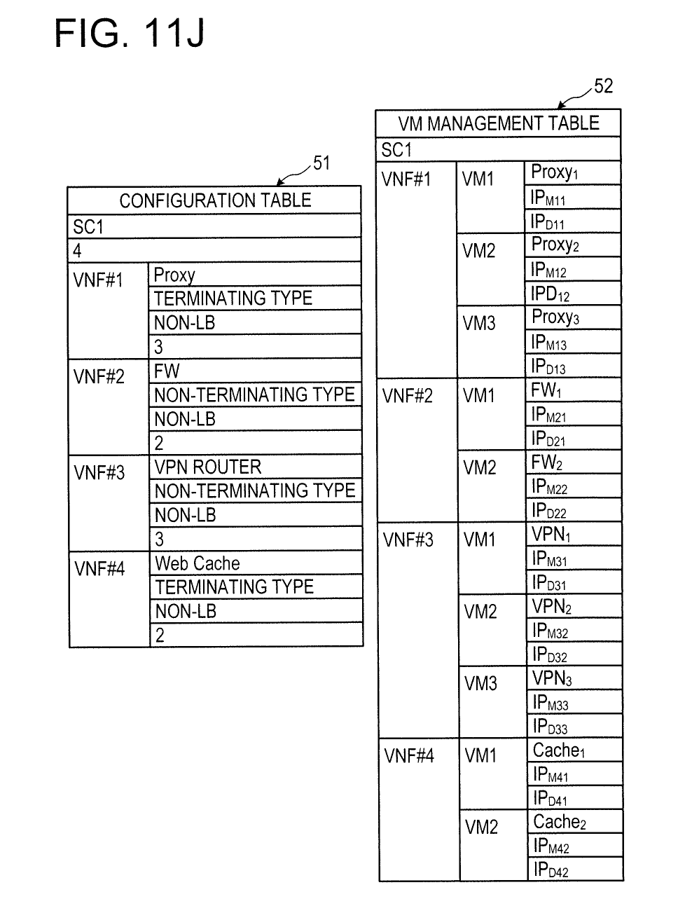

A service chain where the source VNF is an LB has been illustrated in FIGS. 10A to 10E. Hereinafter, a service chain where the source VNF is a non-LB will be described. FIG. 11A is an explanatory view illustrating an example of the operation of the management server 3 at the time of detecting an overload of VNF#3 in the service chain. The service chain illustrated in FIG. 11A is constructed by arranging VNF#1 to VNF#4 in a plurality of stages. For example, VNF#1 has two VMs of Proxy₁ and Proxy₂ of a terminating VNF, and VNF#2 has two VMs of FW₁ and FW₂ of a non-terminating VNF. For example, VNF#3 has two VMs of VPN₁ and VPN₂ of a non-terminating VNF, and VNF#4 has two VMs of Cache₁ and Cache₂ of a terminating VNF. Proxy₁ is destined for a VM (Cache₁) that terminates a traffic, and outputs the traffic to Cache₁ in the destination VNF#4. Proxy₂ is destined for a VM (Cache₂) that terminates a traffic, and outputs the traffic to Cache₂ in the destination VNF#4. VNF#1 outputs two lines of traffics to VNF#4 as the destination VNF via VNF#2 and VNF#3. In the service chain, since the total number of traffics is 2 lines, the traffics may be distributed to all VMs passing through a transfer path by controlling the transfer path.

Upon detecting the overload of a VPN in VNF#3, the monitoring unit 41 notifies the adding unit 42 of an addition request to add a VM (VPN₃) to VNF#3. The monitoring unit 41 notifies the requesting unit 43 of a VNF identifier for identifying the additional VNF#3.

FIG. 11B is an explanatory view illustrating an example of the operation of the management server 3 at the time of adding a VM of VNF#3 and specifying a source VNF. In response to the addition request from the monitoring unit 41, the adding unit 42 adds the third VPN₃ to VNF#3 as illustrated in FIG. 11B. The control unit 45 changes the VM number 51H corresponding to the additional VNF#3 in the configuration table 51 to “3”. The control unit 45 adds the VM identifier 52D, the VMID 52E, the management address 52F, and the transfer address 52G as the VM identification information of VPN₃ corresponding to the additional VNF#3 in the VM management table 52.

FIG. 11C is an explanatory view illustrating an example of the operation of the management server 3 at the time of extracting the number of source VMs and the number of additional VMs. As illustrated in FIG. 11C, the specifying unit 43A refers to the transfer mode 51F in the configuration table 51 to specify a terminating source VNF of a traffic passing through the additional VNF. Here, a VM of the source VNF is Proxy. The requesting unit 43 refers to the LB identifier 51G in the configuration table 51 to determine whether or not the source VNF is LB. When the source VNF is not LB but Proxy, the requesting unit 43 compares the number of source VMs with the number of additional VMs to determine whether or not the additional VM may allocate a traffic. Here, the number of source VMs is two, Proxy₁ and Proxy₂ in VNF#1. The number of additional VMs is three, VPN₁ to VPN₃ in VNF#3.

Since the source VNF is not LB, the requesting unit 43 refers to the configuration table 51 to determine whether or not a traffic may be allocated to the additional VM. When the number of traffics is equal to or larger than the number of additional VMs of VNF including the additional VM, the requesting unit 43 may allocate a traffic to the additional VM by controlling a transfer path of the traffic. Here, when the source VNF is not LB, the number of traffics is calculated as the number of source VMs of the source VNF. In the example of FIG. 11C, since the number of source VMs of the source VNF#1 is two and the number of additional VMs of the additional VNF#3 is three, a traffic may not be allocated to the additional VNF. Therefore, the requesting unit 43 notifies the adding unit 42 of an addition request to add a VM to the source VNF so that the number of source VMs of the source VNF becomes equal to or larger than the number of additional VMs of the additional VNF.

FIG. 11D is an explanatory view illustrating an example of the operation of the management server 3 when a VM is added to the source VNF#1. In response to the addition request from the requesting unit 43, the adding unit 42 adds the third Proxy₃ to the source VNF#1 as illustrated in FIG. 11D. The control unit 45 changes the VM number 51H corresponding to the source VNF#1 in the configuration table 51 to “3”. The control unit 45 adds the VM identifier 52D, the VMID 52E, the management address 52F, and the transfer address 52G as the VM identification information of Proxy₃ corresponding to the source VNF#1 in the VM management table 52. Then, the adding unit 42 requests the resetting unit 44 for a transfer path and an allocation setting of each VM.

FIG. 11E is an explanatory view illustrating an example of the operation of the management server 3 at the time of resetting path. As illustrated in FIG. 11E, the resetting unit 44 recalculates an allocation setting and a transfer path of each VM in order to allocate traffics to all the VMs and sets the recalculated allocation setting and the recalculated transfer path in each VM. As a result, the service chain is reestablished. Upon detecting the overload of VPN of VNF#3, the management server 3 may allocate traffics to all the VMs since the management server 3 adds a VPN and also adds Proxy of the source VNF#1 in conjunction. Then, since the management server 3 is able to distribute the traffics to all VMs, the processing load of the overloaded VNF#3 may be reduced.

When adding a VM to the overloaded VNF, the management server 3 specifies a source VNF of a traffic passing through the additional VNF. The management server 3 calculates the number of traffics by multiplying the number of source VMs of the source VNF by the number of destination VMs of the destination VNF. When the source VNF is non-LB and the number of traffics is smaller than the number of additional VMs, the management server 3 adds a VM to the source VNF. As a result, even when a VM is added to the overloaded VNF, since the management server 3 may reliably allocate the traffics to all the VMs, the processing load of the overloaded VNF may be reduced while distributing the traffics to all the VMs.

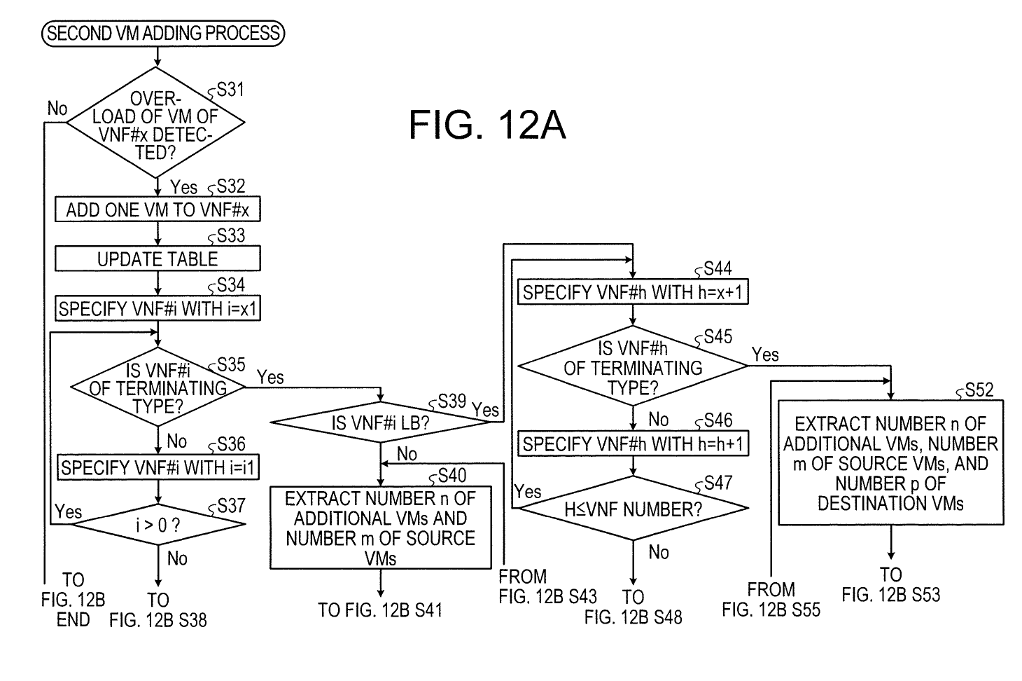

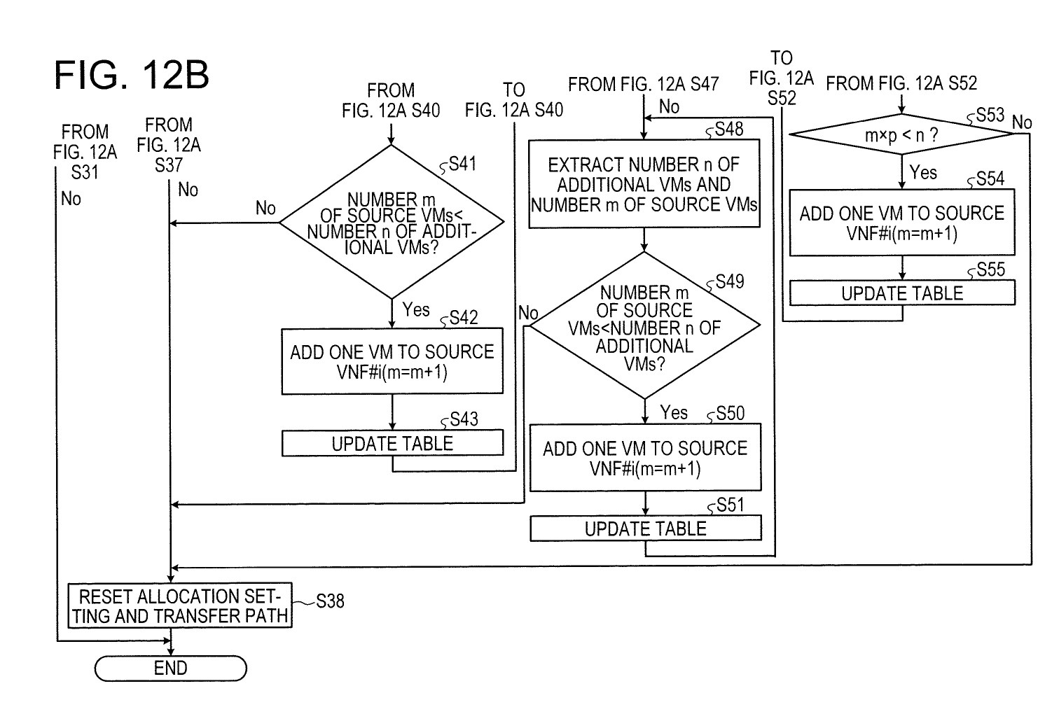

FIG. 12 is a flowchart illustrating an example of the processing operation of the processor 36 in the management server 3 related to a second VM adding process. Referring to FIG. 12, the monitoring unit 41 in the processor 36 determines whether or not an overload of VNF#x in the service chain has been detected (Operation S31). When it is determined that an overload of VNF#x has been detected (“Yes” in Operation S31), the monitoring unit 41 notifies the adding unit 42 of an addition request to add one VM to VNF#x. In response to the addition request, the adding unit 42 in the processor 36 adds one VM to VNF#x (Operation S32). The control unit 45 in the processor 36 updates the configuration table 51 and the VM management table 52 according to the additional VM for the additional VNF (Operation S33).

Furthermore, the specifying unit 43A in the requesting unit 43 in the processor 36 refers to the VNF identifier 51D of the configuration table 51 to specify VNF#i at the previous stage of VNF#x based on x−1=i (Operation S34). The specifying unit 43A refers to the transfer mode 51F of the configuration table 51 to determine whether or not VNF#i is of a terminating type (Operation S35).

When it is determined that VNF#i is not of a terminating type (“No” in Operation S35), the specifying unit 43A refers to the VNF identifier 51D of the configuration table 51 to specify VNF#i at the previous stage based on i=i−1 (Operation S36). The specifying unit 43A determines whether or not i is greater than 0 (Operation S37). When it is determined that i is greater than 0 (“Yes” in Operation S37), the requesting unit 43 proceeds to Operation S35 to determine whether or not VNF#i specified in Operation S36 is of a terminating type.

When it is determined that i is not greater than 0 (“No” in Operation S37), the resetting unit 44 in the processor 36 resets the transfer path and the allocation setting so that the traffics are distributed to all the VMs including the additional VM in the service chain (Operation S38), and then ends the processing operation illustrated in FIG. 12.

When it is determined that VNF#i is of a terminating type (“Yes” in Operation S35), the requesting unit 43 refers to the LB identifier 51G in the configuration table 51 to determine whether or not VNF#i is LB (Operation S39). When it is determined that VNF#i is not LB (“No” in Operation S39), the requesting unit 43 refers to the VM number 51H in the configuration table 51 to extract the number n of additional VMs of the additional VNF#x and the number m of source VMs of the source VNF#i (Operation S40). The requesting unit 43 determines whether or not the number m of source VMs is smaller than the number n of additional VMs (Operation S41).

When it is determined that the number m of source VMs is smaller than the number n of additional VMs (“Yes” in Operation S41), the requesting unit 43 notifies the adding unit 42 of an addition request to add a VM to the source VNF#i. In response to the addition request from the requesting unit 43, the adding unit 42 adds one VM to the source VNF#i (Operation S42). The control unit 45 updates the configuration table 51 and the VM management table 52 according to the addition of VM to the source VNF (Operation S43). Further, the requesting unit 43 proceeds to Operation S40 to extract the number of additional VMs and the number of source VMs in accordance with table update of the additional VM.

When it is determined that the number m of source VMs is not smaller than the number n of additional VMs (“No” in Operation S41), the requesting unit 43 proceeds to Operation S38 to reset the transfer path and the allocation setting so that the traffics are distributed to all the VMs in the service chain. Further, when it is determined that the overload of VNF#x has not been detected (“No” in Operation S31), the monitoring unit 41 ends the processing operation illustrated in FIG. 12.

When it is determined that VNF#i is LB (“Yes” in Operation S39), the specifying unit 43A refers to the VNF identifier 51D in the configuration table 51 to specify VNF#h at the next stage of the additional VNF with h=x+1 (Operation S44). The requesting unit 43 refers to the transfer mode 51F in the configuration table 51 to determine whether or not VNF#h is of a terminating type (Operation S45). When it is determined that VNF#h is not of a terminating type (“No” in Operation S45), the specifying unit 43A refers to the VNF identifier 51D in the configuration table 51 to specify VNF#h at the next stage with h=h+1 (Operation S46).

The requesting unit 43 determines whether or not h is equal to or smaller than the number of VNFs (Operation S47). When it is determined that h is equal to or smaller than the number of VNFs (“Yes” in Operation S47), the requesting unit 43 proceeds to Operation S45 to determine whether or not VNF#h is of a terminating type. When it is determined that h is not equal to or smaller than the number of VNFs (“No” in Operation S47), the requesting unit 43 refers to the VM number 51H in the configuration table 51 to extract the number n of additional VMs and the number m of source VMs (Operation S48).

The requesting unit 43 determines whether or not the number m of source VMs is smaller than the number n of additional VMs (Operation S49). When it is determined that the number m of source VMs is smaller than the number n of additional VMs (“Yes” in Operation S49), the requesting unit 43 notifies the adding unit 42 of an addition request to add a VM to the source VNF#i. In response to the addition request from the requesting unit 43, the adding unit 42 adds one VM to the source VNF#i (Operation S50). Then, the control unit 45 updates the configuration table 51 and the VM management table 52 according to the addition of VM to the source VNF (Operation S51) and then proceeds to Operation S48 to extract the number of source VMs and the number of additional VMs.

Further, when it is determined that VNF#h is of a terminating type (“Yes” in Operation S45), the requesting unit 43 refers to the VM number 51H in the configuration table 51 to extract the number n of additional VMs, the number m of source VMs, and the number p of destination VMs (Operation S52). Further, the requesting unit 43 determines whether or not m×p is smaller than n (Operation S53). When it is determined that m×p is smaller than n (“Yes” in Operation S53), the requesting unit 43 notifies the adding unit 42 of an addition request to add a VM to the source VNF#i. In response to the addition request from the requesting unit 43, the adding unit 42 adds one VM to the source VNF#i (Operation S54). Then, the control unit 45 updates the configuration table 51 and the VM management table 52 according to the addition of VM to the source VNF (Operation S55) and then proceeds to Operation S52 to extract the number of source VMs, the number of additional VMs, and the number of destination VMs. When it is determined that m×p is not smaller than n (“No” in Operation S53), the requesting unit 43 proceeds to Operation S38 to reset the transfer path and the allocation setting. When it is determined that the number m of source VMs is not smaller than the number m of additional VMs (“No” at Operation S49), the requesting unit 43 proceeds to Operation S38 to reset the transfer path and the allocation setting.

When adding a VM to the overloaded VNF, the management server 3 of the second embodiment specifies a source VNF of a traffic passing through the additional VNF. The management server 3 calculates the number of traffics by multiplying the number of source VMs of the source VNF by the number of destination VMs of the destination VNF. When the VM of the source VNF is LB and the number of traffics is smaller than the number of additional VMs, the management server 3 adds an LB to the source VNF. As a result, even when a VM is added to the overloaded VNF, since the management server 3 may reliably allocate the traffics to all the VMs, the processing load of the overloaded VNF may be reduced while distributing the traffics to all the VMs.

When a VM of the source VNF is LB and the number of traffics is equal to or larger than the number of additional VMs, the management server 3 may suppress wasteful addition of LB to the source VNF and reliably allocate the traffics to all VMs by controlling a transfer path. As a result, the processing load of the overloaded VNF may be reduced while distributing the traffics to all VMs.

The management server 3 determines whether or not traffics may be allocated to all VMs in the additional VNF, based on the number of traffics from the source VNF to the destination VNF of the traffics. When the traffics may not be allocated, the management server 3 adds a VM to the source VNF. As a result, the management server 3 may allocate traffics to all VMs.

The management server 3 specifies the traffic destination VNF from the additional VNF. The management server 3 calculates the number of traffics by multiplying the number of source VMs by the number of destination VMs. As a result, the management server 3 may easily calculate the number of traffics in the service chain.

In the second embodiment, the number of traffics is calculated by multiplying the number of source VMs by the number of destination VMs. However, the second embodiment is not limited to such a configuration. For example, when the source VNF is LB, by referring to the allocation setting of the LB, the number of traffics which corresponds to the number of destinations between each LB and a VM in the destination VNF may be extracted. It is assumed that the management server 3 manages allocation settings set for each LB. Further, when the allocation settings are not managed, it is assumed that the management server 3 uses the function of acquiring an allocation setting from each LB. In the example of FIGS. 10A and 10B, since LB₁ allocates traffics to Cache₁ and Cache₂ and LB₂ also allocates traffics to Cache₁ and Cache₂, the number of traffics is four lines.

Further, when a VM is added in conjunction with the additional VM, the selecting unit 43B of the second embodiment is preset so as to add the VM to the source VNF. However, the selecting unit 43B may be preset so as to add a VM to the destination VNF instead of the source VNF and may be appropriately changed in the setting. For example, the selecting unit 43B may add a VM to one of the source VNF and the destination VNF with less virtual resource consumption in the predetermined number of additional VMs, for example, one additional VM. It is also assumed that the management server 3 manages the virtual resource consumption of each VM for each VNF.

Further, the selecting unit 43B may add a VM to one of the source VNF and the destination VNF with a smaller fee that increases with the predetermined number of additional VMs, for example, one additional VM. Here, it is also assumed that the management server 3 manages the usage fee of each VM for each VNF.

Further, the selecting unit 43B may add a VM to one of the source VNF and the destination VNF with the smaller sum of margins of the processing capacity of all VMs in order to suppress the frequency of service chain reestablishment by an auto scale. For example, the phrase “the CPU usage rate of 1−VM” is regarded as the sum of margins of the processing capacity of the VM. The management server 3 compares the sum of margins of the processing capacity of all VMs of the source VNF with the sum of margins of the processing capacity of all VMs of the destination VNF based on the CPU usage rate of each VM and adds a VM to a VNF with the smaller sum of margins.

Further, in order to suppress the frequency of addition of VM to VNF, the selecting unit 43B adds a VM to one of the source VNF and the destination VNF with the larger number of traffic-allocable VMs with the VM addition. That is, “(the number of source VMs+1)× the number of destination VMs” is compared with “the number of source VMs× (the number of destination VMs+1),” and a VM is added to the larger VNF.

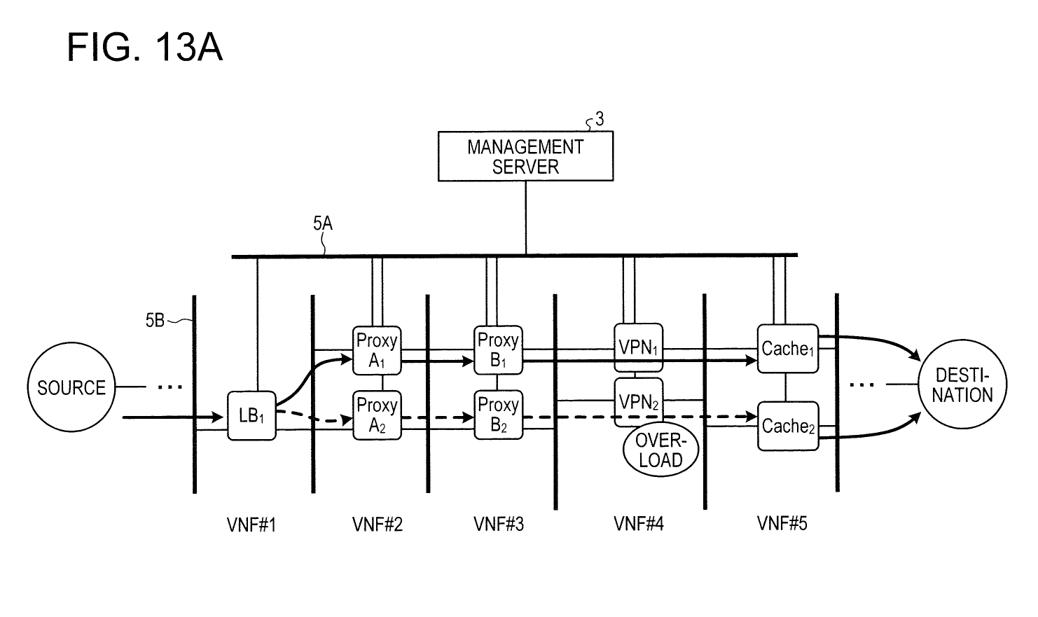

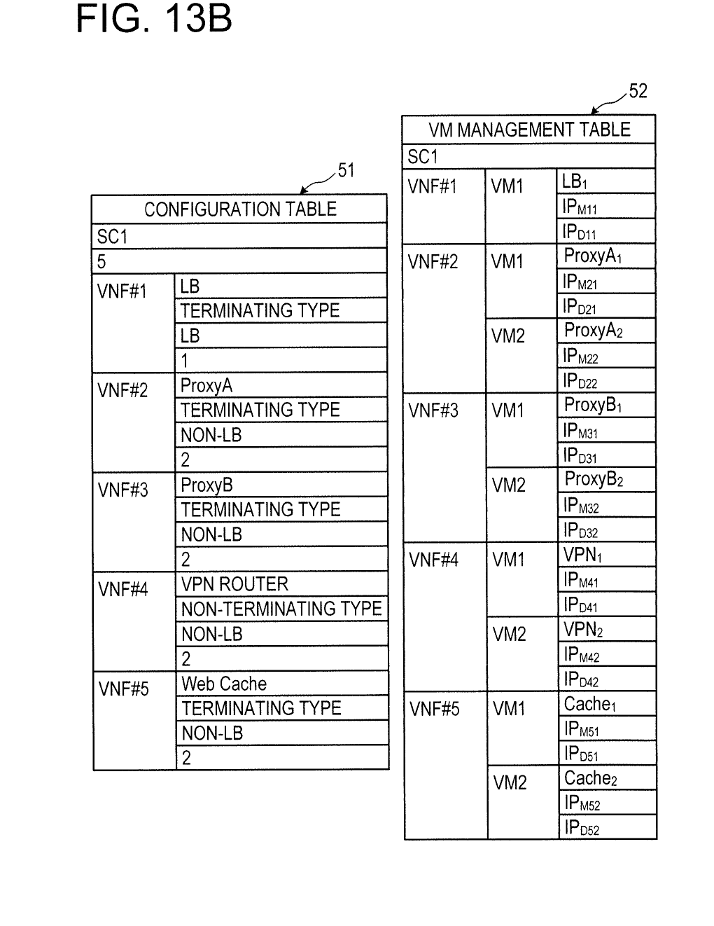

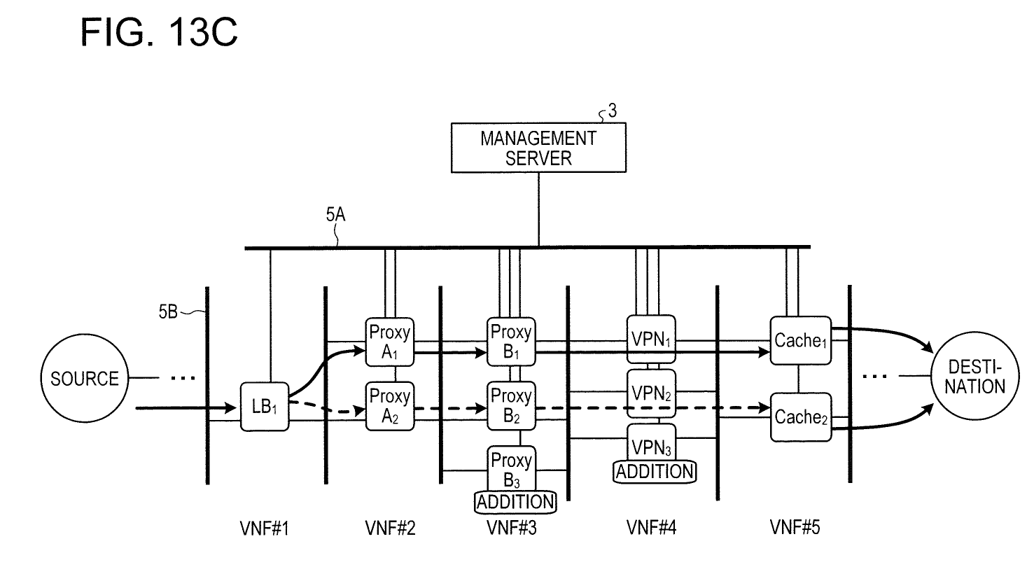

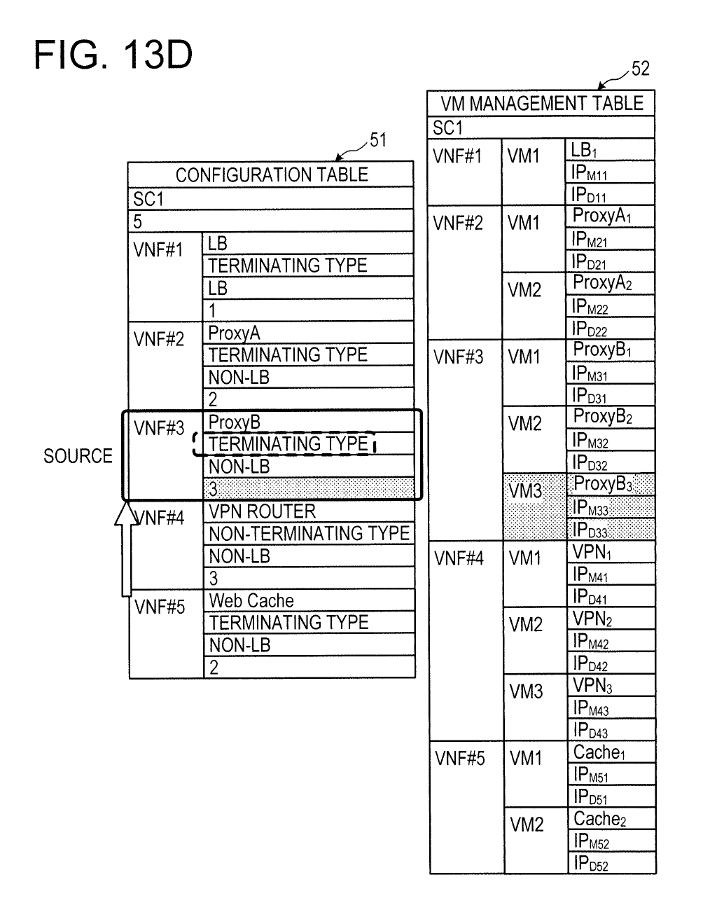

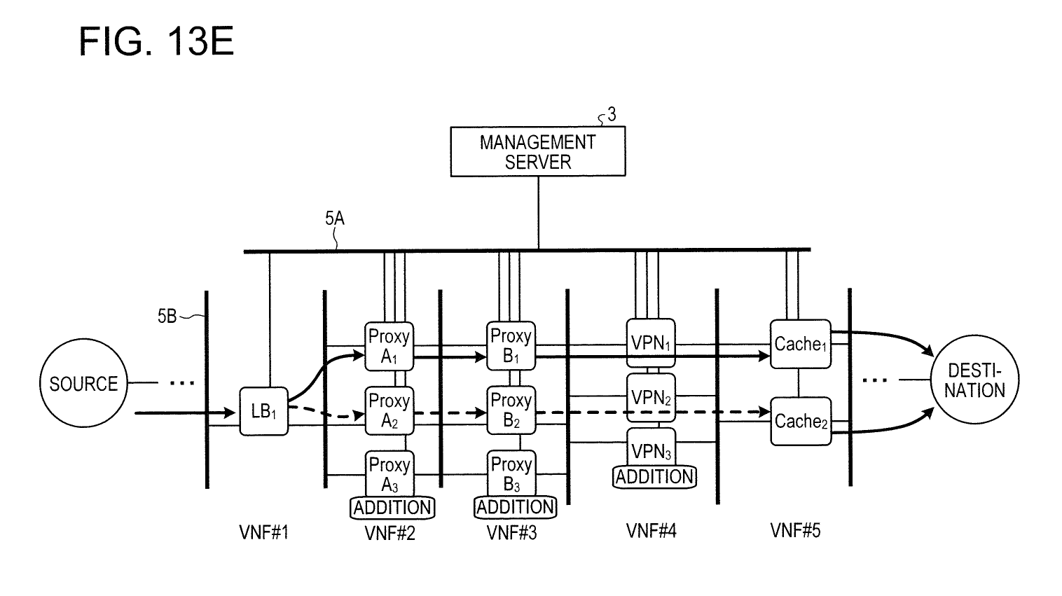

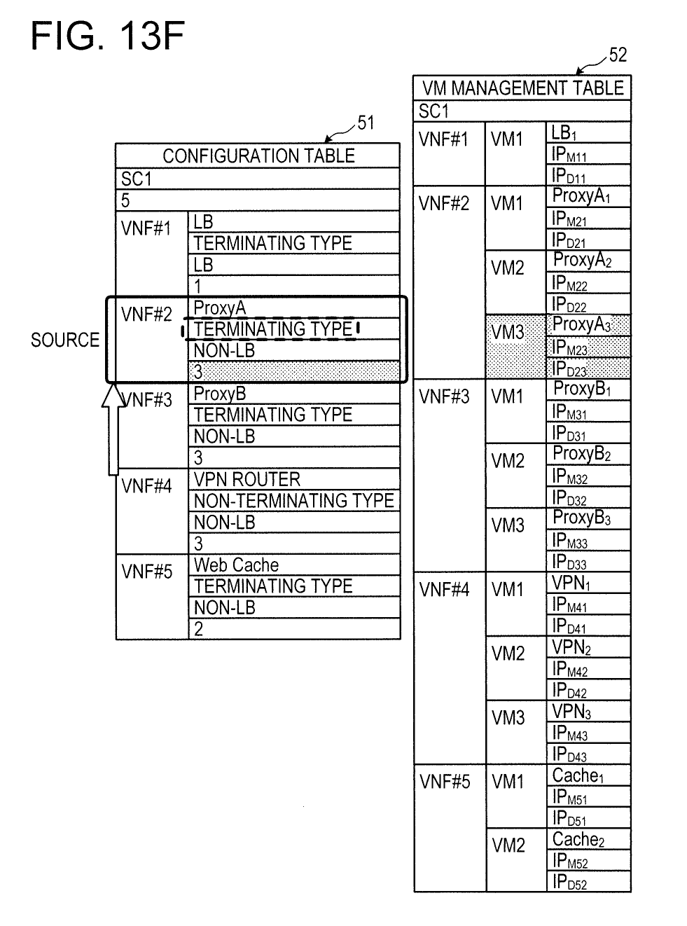

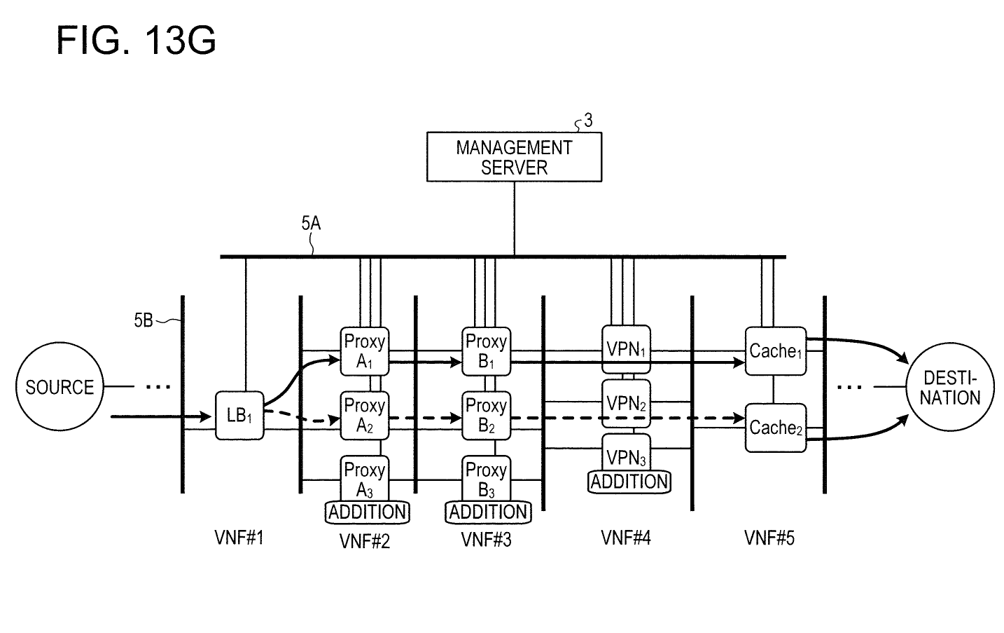

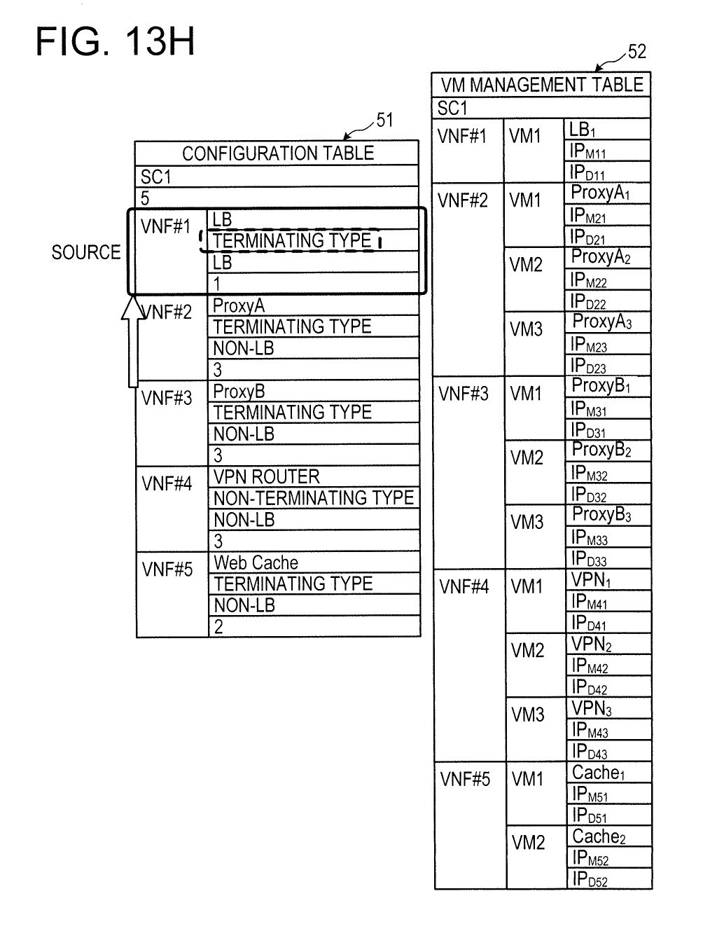

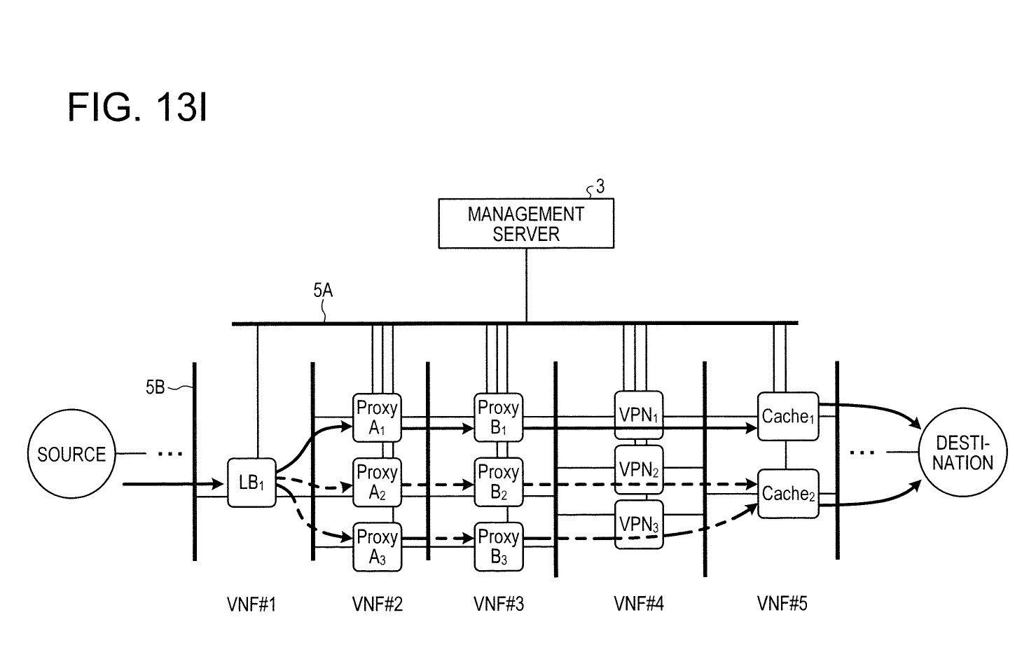

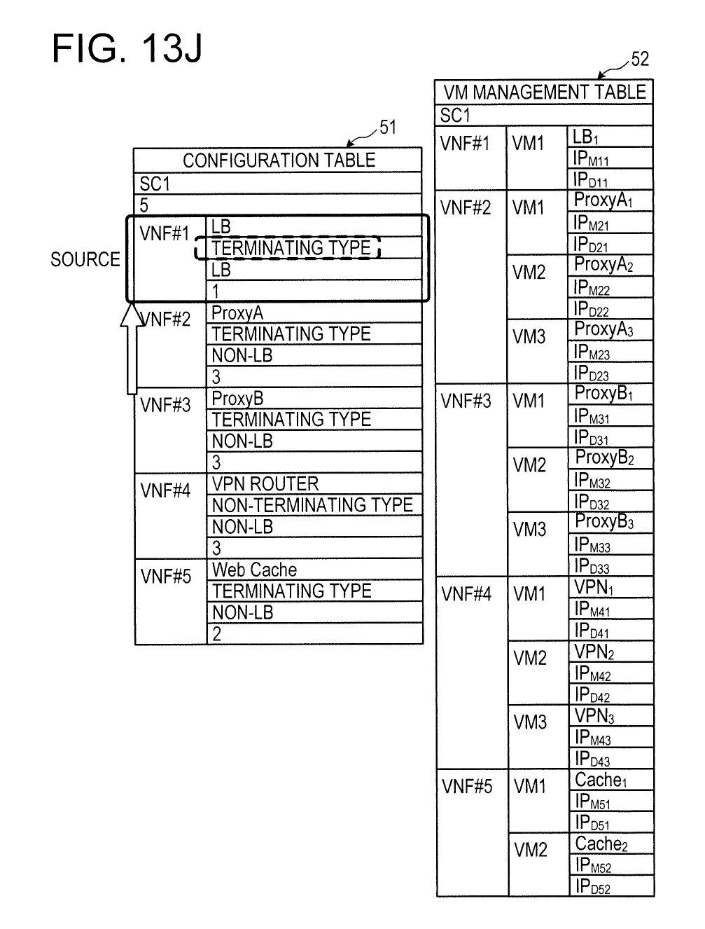

A case where a traffic may be allocated to a VM added in conjunction has been exemplified in the first and second embodiments. However, it is not always possible to allocate a traffic to a VM added in conjunction. Therefore, when no traffic may be allocated to the VM added in conjunction, another VM is further added in conjunction, as will be described below with a third embodiment. FIG. 13A is an explanatory view illustrating an example of the operation of the management server 3 at the time of detecting an overload of VNF#4 in a service chain according to a third embodiment. In the third embodiment, the same configurations as those in the service chain systems of the first and second embodiments are denoted by the same reference numerals and explanation on the overlapping configuration and operation thereof will not be repeated.

### Third Embodiment

The service chain illustrated in FIG. 13A is constructed by arranging VNF#1 to VNF#5 in a plurality of stages. For example, VNF#1 has one VM of LB₁ of a terminating VNF, and VNF#2 has two VMs of ProxyA₁ and ProxyA₂ of a terminating VNF. For example, VNF#3 has two VMs of ProxyB₁ and ProxyB₂ of a terminating VNF, and VNF#4 has two VMs of VPN₁ and VPN₂ of a non-terminating VNF. For example, VNF#5 has two VMs of Cache₁ and Cache₂ of a terminating VNF.

LB₁ assumes VMs (ProxyA₁ and ProxyA₂) that terminate traffics, as destinations, and outputs a traffic to two ProxyA₁ and ProxyA₂ in the destination VNF#2. ProxyA₁ assumes a VM (ProxyB₁) that terminates the traffic, as a destination, and outputs the traffic to ProxyB₁ in the destination VNF#3. ProxyA₂ assumes a VM (ProxyB₂) that terminates the traffic, as a destination, and outputs the traffic to ProxyB₂ in the destination VNF#3. ProxyB₁ assumes a VM (Cache₁) that terminates the traffic, as a destination, and outputs the traffic to Cache₁ in the destination VNF#5. ProxyB₂ assumes a VM (Cache₂) that terminates the traffic, as a destination, and outputs the traffic to Cache₂ in the destination VNF#5.

Upon detecting an overload of VPN in VNF#4, the monitoring unit 41 notifies the adding unit 42 of an addition request to add a VM (VPN₃) to VNF#4. The monitoring unit 41 notifies the requesting unit 43 of a VNF identifier for identifying the additional VNF#4.

FIG. 13B is an explanatory view illustrating an example of the operation of the management server 3 at the time of adding VM to VNF#3 and VNF#4. In response to the addition request from the monitoring unit 41, the adding unit 42 adds the third VM (VPN₃) in VNF#4 as illustrated in FIG. 13B. The control unit 45 changes the VM number 51H corresponding to the additional VNF#4 in the configuration table 51 to “3”. The control unit 45 adds the VM identifier 52D, the VMID 52E, the management address 52F, and the transfer address 52G as the VM identification information of VPN₃ corresponding to the additional VNF#4 in the VM management table 52.

The specifying unit 43A refers to the transfer mode 51F in the configuration table 51 to specify the terminating source VNF#3 of a traffic passing through the additional VNF#4. The VMs of the source VNF#3 are ProxyB₁ and ProxyB₂. The requesting unit 43 refers to the LB identifier 51G in the configuration table 51 to determine whether or not the source VNF#3 is LB. Since the source VNF#3 is not LB but ProxyB₁ and ProxyB₂, the requester 43 notifies the adding unit 42 of an addition request to add a VM to the source VNF#3 so that the number of source VMs of the source VNF#3 becomes equal to or larger than the number of additional VMs of the additional VNF#4.

In response to the addition request from the requesting unit 43, the adding unit 42 adds the third ProxyB₃ to the source VNF#3. The control unit 45 changes the VM number corresponding to the source VNF#3 in the configuration table 51 to “3”. The control unit 45 adds the VM identifier 52D, the VMID 52E, the management address 52F, and the transfer address 52G as the VM identification information of ProxyB₃ corresponding to the source VNF#3 in the VM management table 52.

FIG. 13C is an explanatory view illustrating an example of the operation of the management server 3 at the time of adding VM to VNF#2. As illustrated in FIG. 13C, the specifying unit 43A refers to the transfer mode 51F in the configuration table 51 to specify the source VNF#2 which is a terminal VNF of a traffic passing through the additional VNF#3. The VMs of the source VNF#2 are ProxyA₁ and ProxyA₂. The requesting unit 43 refers to the LB identifier 51G in the configuration table 51 to determine whether or not the source VNF#2 is LB. Since the source VNF#2 is not LB but ProxyA₁ and ProxyA₂, the requester 43 notifies the adding unit 42 of an addition request to add a VM to the source VNF#2 so that the number of source VMs of the source VNF#2 becomes equal to or larger than the number of additional VMs of the additional VNF#3.

In response to the addition request from the requesting unit 43, the adding unit 42 adds the third ProxyA₃ to the source VNF#2. The control unit 45 changes the VM number corresponding to the source VNF#2 in the configuration table 51 to “3”. The control unit 45 adds the VM identifier 52D, the VMID 52E, the management address 52F, and the transfer address 52G as the VM identification information of ProxyA₃ corresponding to the source VNF#2 in the VM management table 52.

FIG. 13D is an explanatory view illustrating an example of the operation of the management server 3 at the time of specifying the source VNF. The specifying unit 43A refers to the transfer mode 51F of the configuration table 51 illustrated in FIG. 13D to specify the source VNF#1 which is a terminating VNF of a traffic passing through the additional VNF#2. The VM of the source VNF#1 is LB₁. The requesting unit 43 refers to the LB identifier 51G in the configuration table 51 to determine whether or not the source VNF#1 is LB. Since the source VNF#1 is LB, the requesting unit 43 determines whether or not a traffic may be allocated to LB. A criterion for determination as to whether or not a traffic may be allocated may be, for example, when the number of source VMs of the source VNF is equal to or larger than the number of additional VMs of the additional VNF, when the VM of the source VNF is LB, or when the source VNF is assumed as a source (user) of the whole communication. In FIG. 13D, since the source VNF#1 is LB, the requesting unit 43 determines that a traffic may be allocated to LB. That is, the source VNF#1 of a traffic arriving at ProxyA₁ to ProxyA₃ in VNF#2 is LB. Therefore, LB₁ may allocate a traffic to ProxyA₁ to ProxyA₃.

FIG. 13E is an explanatory view illustrating an example of the operation of the management server 3 at the time of resetting path. As illustrated in FIG. 13E, the resetting unit 44 in the management server 3 recalculates an allocation setting of LB and a transfer path of each VM in order to allocate traffics to all added VMs, and sets the recalculated allocation setting in LB and the recalculated transfer path in each VM. Then, the service chain is reestablished. Upon detecting an overload of VNF#4, since the management server 3 adds a VM to VNF#4 and also adds a VM to VNF#3 and VNF#2, traffics may be allocated to all VMs including the additional VM. Then, the management server 3 may reduce the processing load of the overloaded VNF while distributing the traffics to all VMs.

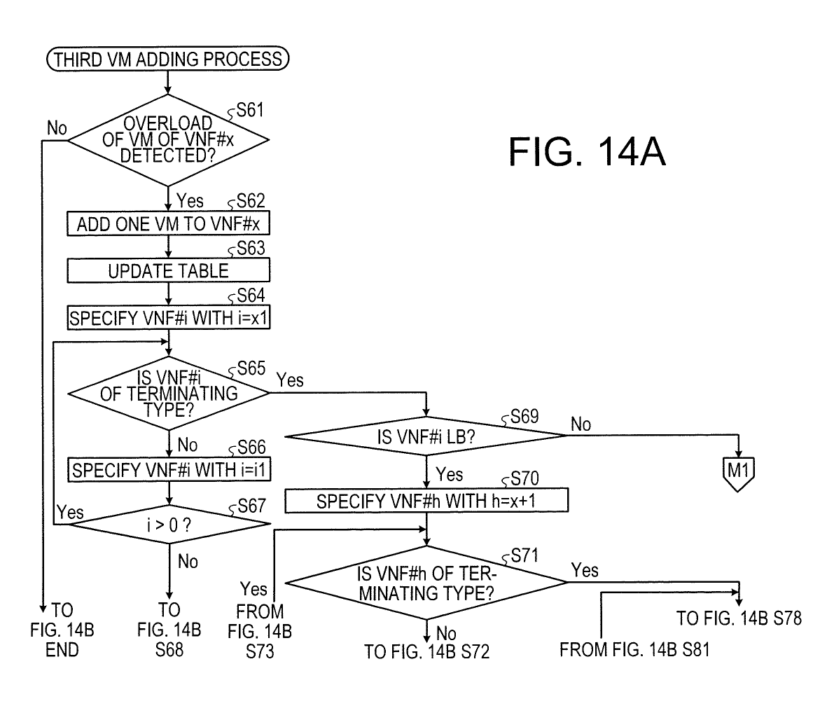

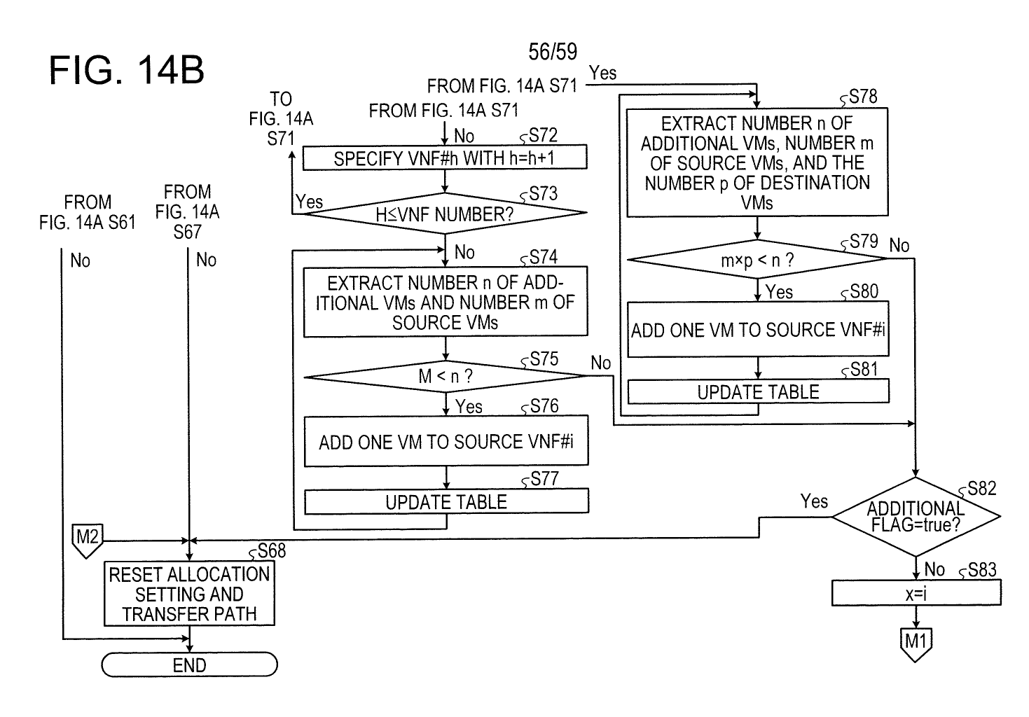

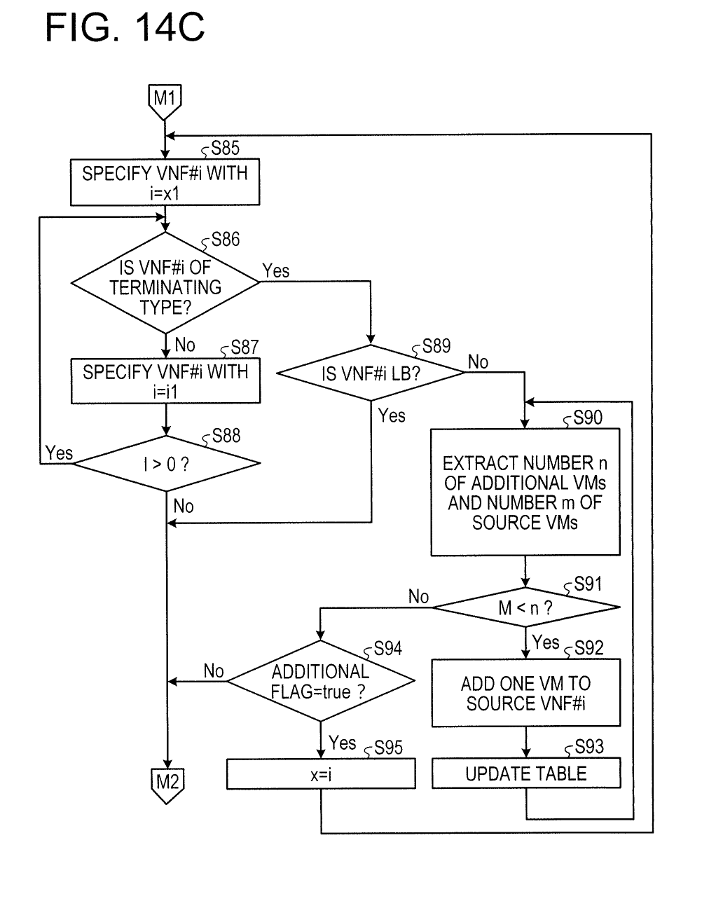

FIGS. 14A and 14B are flowcharts illustrating an example of the processing operation of the processor 36 in the management server 3 related to a third VM adding process. In FIG. 14A, the monitoring unit 41 in the processor 36 determines whether or not an overload of VNF#x in the service chain has been detected (Operation S61). When it is determined that an overload of VNF#x has been detected (“Yes” in Operation S61), the monitoring unit 41 notifies the adding unit 42 of an addition request to add one VM to VNF#x. In response to the addition request, the adding unit 42 adds one VM to VNF#x (Operation S62). The control unit 45 in the processor 36 updates the configuration table 51 and the VM management table 52 according to the addition of VM to the additional VNF (Operation S63).

Further, the requesting unit 43 refers to the VNF identifier 51D of the configuration table 51 to specify VNF#i at the previous stage of VNF#x based on x−1=i (Operation S64). The specifying unit 43A refers to the transfer mode 51F of the configuration table 51 to determine whether or not VNF#i is of a terminating type (Operation S65).

When it is determined that VNF#i is not of a terminating type (“No” in Operation S65), the specifying unit 43A refers to the VNF identifier 51D of the configuration table 51 to specify VNF#i at the previous stage based on i=i−1 (Operation S66). The specifying unit 43A determines whether or not i is larger than 0 (Operation S67). When it is determined that i is larger than 0 (“Yes” in Operation S67), the requesting unit 43 proceeds to Operation S65 to determine whether or not VNF#i specified in Operation S66 is of a terminating type.

When it is determined that i is not larger than 0 (“No” in Operation S67), the resetting unit 44 in the processor 36 resets the transfer path and the allocation setting so that the traffics are distributed to all VMs including the additional VM in the service chain (Operation S68), and then ends the processing operation illustrated in FIG. 14A.

When it is determined that VNF#i is of a terminating type (“Yes” in Operation S65), the requesting unit 43 refers to the LB identifier 51G in the configuration table 51 to determine whether VNF#i is LB (Operation S69). When it is determined that VNF#i is LB (“Yes” in Operation S69), the specifying unit 43A refers to the VNF identifier 51D in the configuration table 51 to specify VNF#h at the next stage of the additional VNF with h=x+1, and sets an additional flag to false (Operation S70). Here, the additional flag is a flag indicating whether or not another VM is being added in conjunction with addition of VM to the overloaded VNF. Here, the term “false” indicates a state in which another VM is not added in conjunction and the term “true” indicates a state in which another VM is added in conjunction. The specifying unit 43A refers to the transfer mode 51F in the configuration table 51 to determine whether or not VNF#h is of a terminating type (Operation S71). When it is determined that VNF#h is not of a terminating type (“No” in Operation S71), the specifying unit 43A refers to the VNF identifier 51D in the configuration table 51 to specify VNF#h at the next stage with h=h+1 (Operation S72).

The requesting unit 43 determines whether or not h is equal to or smaller than the number of VNFs (Operation S73). When it is determined that h is equal to or smaller than the number of VNFs (“Yes” in Operation S73), the requesting unit 43 proceeds to Operation S71 to determine whether or not VNF#h is of a terminating type. When it is determined that h is not equal to or smaller than the number of VNFs (“No” in Operation S73), the requesting unit 43 refers to the VM number 51H in the configuration table 51 to extract the number n of additional VMs and the number m of source VMs (Operation S74).

The requesting unit 43 determines whether or not the number m of source VMs is smaller than the number n of additional VMs (Operation S75). When it is determined that the number m of source VMs is smaller than the number n of additional VMs (“Yes” in Operation S75), the requesting unit 43 notifies the adding unit 42 of an addition request to add a VM to the source VNF#i. In response to the addition request from the requesting unit 43, the adding unit 42 adds one VM to the source VNF#i and sets an additional flag to true (Operation S76). Then, the control unit 45 updates the configuration table 51 and the VM management table 52 according to the addition of VM to the source VNF (Operation S77) and proceeds to Operation S74 to extract the number of source VMs and the number of additional VMs.

Further, when it is determined that VNF#h is of a terminating type (“Yes” in Operation S71), the requesting unit 43 refers to the VM number 51H in the configuration table 51 to extract the number n of additional VMs, the number m of source VMs, and the number p of destination VMs (Operation S78). Further, the requesting unit 43 determines whether or not m×p is smaller than n (Operation S79). When it is determined that m×p is smaller than n (“Yes” in Operation S79), the requesting unit 43 notifies the adding unit 42 of an addition request to add a VM to the source VNF#i. In response to the addition request from the requesting unit 43, the adding unit 42 adds one VM to the source VNF#i and sets an additional flag to true (Operation S80). Then, the control unit 45 updates the configuration table 51 and the VM management table 52 according to the addition of VM to the source VNF (Operation S81) and then proceeds to Operation S78 to extract the number of source VMs, the number of additional VMs, and the number of destination VMs. When it is determined that m×p is not smaller than n (“No” in Operation S79), the requesting unit 43 determines whether or not the additional flag is true (Operation S82).

When it is determined that the additional flag is true (“Yes” in Operation S82), the requesting unit 43 proceeds to Operation S68 to reset the transfer path and the allocation setting so as to distribute the traffics to all VMs including the additional VM. When it is determined that the additional flag is not true (“No” in Operation S82), the requesting unit 43 sets x to i (Operation S83) and then proceeds to M1 in FIG. 14B. Further, when VNF#i is not LB (“No” in Operation S69), the requesting unit 43 proceeds to M1 in FIG. 14B. When it is determined that the overload of VNF#x is not detected (“No” in Operation S61), the monitoring unit 41 ends the processing operation illustrated in FIG. 14A. When it is determined that the number m of source VMs is not smaller than the number n of additional VMs (“No” in Operation S75), the requesting unit 43 proceeds to Operation S82 to determine whether or not the additional flag is true.

In M1 of FIG. 14B, the requesting unit 43 refers to the VNF identifier 51D of the configuration table 51 to specify VNF#i at the previous stage of VNF#x based on i=x−1 (Operation S85). The requesting unit 43 refers to the transfer mode 51F of the configuration table 51 to determine whether or not VNF#i is of a terminating type (Operation S86).

When it is determined that VNF#i is not of a terminating type (“No” in Operation S86), the requesting unit 43 refers to the VNF identifier 51D of the configuration table 51 to specify VNF#i at the previous stage based on i=i−1 (Operation S87). The requesting unit 43 determines whether i is larger than 0 (Operation S88). When it is determined that i is larger than 0 (“Yes” in Operation S88), the requesting unit 43 proceeds to Operation S86 to determine whether or not VNF#i specified in Operation S87 is of a terminating type.

When it is determined that i is not larger than 0 (“No” in Operation S88), the resetting unit 44 in the processor 36 proceeds to M2 illustrated in FIG. 14A to reset the transfer path and the allocation setting so that the traffics are distributed to all VMs including the additional VM.

When it is determined that VNF#i is of a terminating type (“Yes” in Operation S86), the requesting unit 43 refers to the LB identifier 51G in the configuration table 51 to determine whether VNF#i is LB (Operation S89). When it is determined that VNF#i is LB (“Yes” in Operation S89), the requesting unit 43 proceeds to M2 illustrated in FIG. 14A to reset the transfer path and the allocation setting so that the traffics are distributed to all VMs including the additional VM.

When it is determined that VNF#i is not LB (“No” in Operation S89), the requesting unit 43 refers to the VM number 51H in the configuration table 51 to extract the number n of additional VMs of the additional VNF#x and the number m of source VMs of the source VNF#i, and sets the additional flag to false (Operation S90). The requesting unit 43 determines whether or not the number m of source VMs is equal to or smaller than the number n of additional VMs (Operation S91).

When it is determined that the number m of source VMs is equal to or smaller than the number n of additional VMs (“Yes” in Operation S91), in response to the addition request from the requesting unit 43, the adding unit 42 adds one VM to the source VNF#i and sets the additional flag to true (Operation S92). The control unit 45 updates the configuration table 51 and the VM management table 52 according to addition of VM to the source VNF (Operation S93). Further, the requesting unit 43 proceeds to Operation S90 to extract the number of additional VMs and the number of source VMs according to the table update of the additional VM.

When it is determined that the number m of source VMs is not equal to or smaller than the number n of additional VMs (“No” in Operation S91), the requesting unit 43 determines whether or not the additional flag is true (Operation S94). When it is determined that the additional flag is not true (“No” in Operation S94), the requesting unit 43 proceeds to M2 illustrated in FIG. 14A to reset the transfer path and the allocation setting so that the traffics are distributed to all VMs including the additional VM. When it is determined that the additional flag is true (“Yes” in Operation S94), the requesting unit 43 sets x to i (Operation S95) and proceeds to Operation S85 to specify the source VNF.

When adding a VM to the overloaded VNF#4, the management server 3 of the third embodiment specifies the source VNF#3 of a traffic passing through VNF#4 and adds a VM to the source VNF#3 so that the number of additional VMs of the additional VNF#4 becomes equal to or larger than number of source VMs of the source VNF#3. When adding a VM to VNF#3, the management server 3 specifies the source VNF#2 of a traffic passing through VNF#3 and adds a VM to the source VNF#2 so that the number of additional VMs of the additional VNF#3 becomes equal to or larger than number of source VMs of the source VNF#2. Furthermore, when adding a VM to VNF#2, the management server 3 specifies the source VNF#1 of a traffic passing through VNF#2 and ends the VM adding process since the source VNF#1 is LB. That is, even when no traffic may be allocated to a VM added in conjunction, another VM is further added in conjunction. As a result, even when a VM is added to the overloaded VNF, since the management server 3 may reliably allocate the traffics to all VMs, the processing load of the overloaded VNF may be reduced while distributing the traffics to all VMs.

A case where a VM is added to an overloaded VNF has been exemplified in the above embodiment, but the embodiment is not limited to such a case of overload as long as a VM is added to a VNF. In the above embodiment, the management server 3 adds one VM to another VNF in conjunction with the VM addition. However, without being limited to one VM, the management server 3 may add two or more VMs so that traffics are allocated to all VMs.

Various elements of various units illustrated in the drawing are not necessarily physically configured as illustrated in the drawing. In other words, the specific forms of distribution and integration of various units are not limited to those illustrated in the drawings, but all or some thereof may be distributed or integrated functionally or physically in arbitrary units depending on various kinds of loads, usage conditions, etc.

Further, the various processing functions performed in the respective units may be entirely or partially executed on a CPU, a digital signal processor (DSP), a field programmable gate array (FPGA), etc. Furthermore, the various processing functions may be entirely or partially executed on a program analyzed and executed by a CPU or the like, or on hardware using wired logic.

An area for storing various kinds of information may be, for example, a read only memory (ROM) or a random access memory (RAM) such as a synchronous dynamic random access memory (SDRAM), a magneto-resistive random access memory (MRAM), a non-volatile random access memory (NVRAM), or the like.

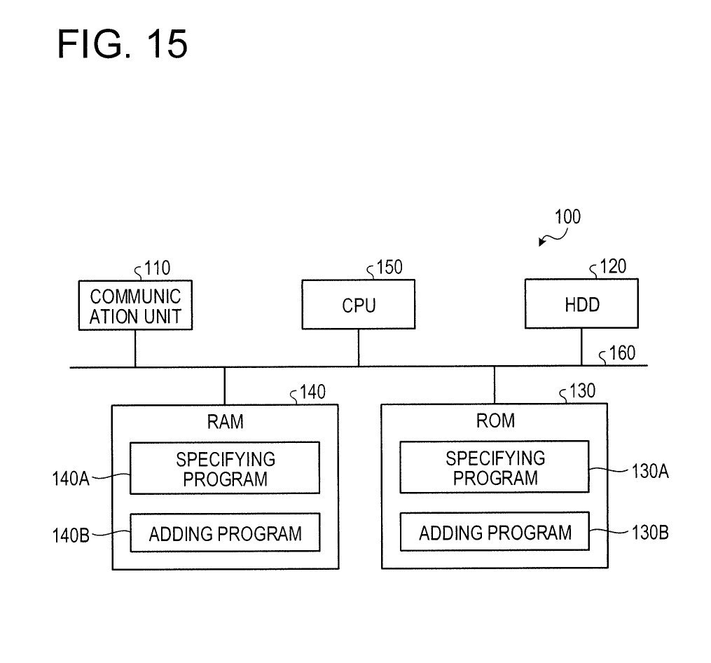

The various processes illustrated and described in the exemplary embodiments may be realized by causing a processor such as a CPU in a computer to execute a prepared program. The following description will be given to an example of an information processing apparatus 100 that executes a program having the functions of the above embodiments. FIG. 15 is an explanatory view illustrating an example of an information processing apparatus 100 that executes a control program.

The information processing apparatus 100 that executes control programs illustrated in FIG. 15 includes a communication unit 110, an HDD 120, a ROM 130, a RAM 140, and a CPU 150. The communication unit 110, the HDD 120, the ROM 130, the RAM 140, and the CPU 150 are interconnected via a bus 160. The communication unit 110 is connected to and communicates with another information processing apparatus (not illustrated). Then, in communication with the another information processing apparatus, the information processing apparatus 100 controls a group of virtual machines that execute predetermined functions arranged in a plurality of stages on a virtual area in the another information processing apparatus.

The control programs that exhibit the functions of the above embodiments are stored in advance in the ROM 130. The ROM 130 stores a specifying program 130A and an adding program 130B as the control programs. Instead of the ROM 130, the control programs may be stored in a computer-readable recording medium with a drive (not illustrated), for example, a portable recording medium such as a CD-ROM, a DVD disc, or a USB memory, a semiconductor memory such as a flash memory, etc.

The CPU 150 reads the specifying program 130A from the ROM 130 and causes the read specifying program 130A to function as a specifying process 140A on the RAM 140. Further, the CPU 150 reads the adding program 130B from the ROM 130 and causes the read adding program 130B to function as an adding process 140B on the RAM 140.

When adding a virtual machine to a group of virtual machines that execute the first function, the CPU 150 specifies a group of virtual machines that execute the second function of a source at a source address of a traffic passing through the group of virtual machines executing the first function. The CPU 150 adds a virtual machine to the specified virtual machine group that executes the second function, based on the number of virtual machines in the specified virtual machine group that executes the second function. As a result, even when a virtual machine is added, traffics may be distributed to all the virtual machines.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A control device configured to control a plurality of virtual machine groups arranged on a plurality of stages, the plurality of virtual machine groups performing predetermined functions, the control device comprising:
a memory; and
a processor coupled to the memory and the processor configured to:
specify, when a first virtual machine is added into a first virtual machine group of the plurality of virtual machine groups configured to perform a first function of the predetermined functions, a second virtual machine group of the plurality of virtual machine groups configured to perform a second function of the predetermined functions, the second virtual machine group being arranged on a forefront stage of the plurality of stages; and
add a second virtual machine into the second virtual machine group based on a number of second virtual machines in the second virtual machine group.

2. The control device according to claim 1,
wherein the processor is further configured to request to add the second virtual machine into the second virtual machine group according to a number of first virtual machines in the first virtual machine group.

3. The control device according to claim 2,
wherein the processor is configured to:
determine whether or not a traffic transferred from the second virtual machine group may be passed through the first virtual machines, based on a number of lines to which the traffic is distributed from the second virtual machine group to a third virtual machine group configured to perform a third function of the predetermined functions, the third virtual machine group being assigned on an end stage of the plurality of stages, and
request to add the second virtual machine into the second virtual machine group when the traffic may not be passed through the first virtual machines.

4. The control device according to claim 3,
wherein the processor is configured to:
specify the third virtual machine group, based on information of the first virtual machine group, and
calculate the number of lines by multiplying the number of second virtual machines by a number of third virtual machines in the third virtual machine group.

5. The control device according to claim 3,
wherein the second virtual machine is a load balancer to distribute the traffic, and
wherein the processor is configured to calculate the number of lines, based on a number of lines to which a traffic is distributed by the second virtual machine.

6. The control device according to claim 1,
wherein, when the second virtual machine is added into the second virtual machine group, the processor is configured to specify a fourth virtual machine group of the plurality of virtual machine groups configured to perform a fourth function of the predetermined functions, the fourth virtual machine group being arranged next to the second virtual machine group, and
wherein the processor is configured to request to add a fourth virtual machine into the fourth virtual machine group, based on a number of forth virtual machines in the fourth virtual machine group.

7. The control device according to claim 1,
wherein the processor is configured to specify the second virtual machine group of terminating arranged at preceding stage of the first virtual machine group, based on positions of the plurality of stages to arrange the plurality of virtual machine groups.

8. The control device according to claim 4,
wherein the processor is configured to specify the third virtual machine group of terminating arranged at a next stage after the first virtual machine group, based on positions of the plurality of stages to arrange the plurality of virtual machine groups.

9. A control device configured to control a plurality of virtual machine groups arranged on a plurality of stages, the plurality of virtual machine groups performing predetermined functions, the control device comprising:
a memory; and
a processor coupled to the memory and the processor configured to:
specify, when a first virtual machine is added into a first virtual machine group of the plurality of virtual machine groups configured to perform a first function of the predetermined functions,
a second virtual machine group of the plurality of virtual machine groups configured to perform a second function of the predetermined functions, the second virtual machine group being arranged on a forefront stage of the plurality of stage, and
a third virtual machine group of the plurality of virtual machine groups configured to perform a third function of the predetermined functions, the third virtual machine group being assigned on an end stage of the plurality of stages;
select one of the second virtual machine group and the third virtual machine group;
add a second virtual machine into the second virtual machine group according to a number of second virtual machines in the second virtual machine group, when the second virtual machine group is selected; and
add a third virtual machine into the third virtual machine group according to a number of third virtual machines in the third virtual machine group, when the third virtual machine group is selected.

10. The control device according to claim 9,
wherein the processor is configured to:
compare a first amount increased of virtual resource consumption in a case where the second virtual machine of a predetermined number is added into the second virtual machine group, with a second amount increased of virtual resource consumption in a case where the third virtual machine of a predetermined number is added into the third virtual machine group; and
select one of the second virtual machine group and the third virtual machine group with less amount of the virtual resource consumption.

11. The control device according to claim 9,
wherein the processor is configured to:
compare a first amount increased of a fee in a case where the second virtual machine of a predetermined number is added into the second virtual machine group, with a second amount increased of a fee in a case where the third virtual machine of a predetermined number is added into the third virtual machine group; and
select one of the second virtual machine group and the third virtual machine group with less amount of the fee.

12. The control device according to claim 9,
wherein the processor is configured to:
compare a sum of margins of processing capacity of the second virtual machine, with a sum of margins of processing capacity of the third virtual machine; and
select one of the second virtual machine group and the third virtual machine group with a smaller sum of the margins of processing capacity.

13. The control device according to claim 9,
wherein the processor is configured to:
compare a first amount increased of the first virtual machine to which a traffic transferred from the second virtual machine group is allocable in a case where the second virtual machine of a predetermined number is added into the second virtual machine group, with a second amount increased of the first virtual machine to which the traffic is allocable in a case where the third virtual machine of a predetermined number is added into the third virtual machine group; and
select one of the second virtual machine group and the third virtual machine group with a larger amount increased of virtual machines.

14. The control device according claim 1,
wherein the second virtual machine is a load balancer to distribute the traffic, and
wherein the processor is configured to increase a number of lines to which a traffic transferred from the load balancer is distributed, or add the load balancer into the second virtual machine group so as to the traffic is allocable into the first virtual machine.

15. A control method configured to control a plurality of virtual machine groups arranged on a plurality of stages, the plurality of virtual machine groups performing predetermined functions, the control method comprising:
specifying, when a first virtual machine is added into a first virtual machine group of the plurality of virtual machine groups configured to perform a first function of the predetermined functions, a second virtual machine group of the plurality of virtual machine groups configured to perform a second function of the predetermined functions, the second virtual machine group being arranged on a forefront stage of the plurality of stages; and
adding a second virtual machine into the second virtual machine group based on a number of second virtual machines in the second virtual machine group, by a processor.
